(19) United States
(12) Patent Application Publication
(10) Pub. No.: US 2009/0319612 A1
(43) Pub. Date: Dec. 24, 2009

(54) Information distribution system, terminal apparatus, distribution server and introduction server in the information distribution system, and recording medium on which program thereof is recorded

(75) Inventor: Hideki Matsuo, Nagoya-shi (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, Nagoya-Shi (JP)

(21) Appl. No.: 12/457,631

(22) Filed: Jun. 17, 2009

(30) Foreign Application Priority Data
Jun. 19, 2008 (JP) 2008-160149

(51) Int. Cl. G06F 15/16

(52) U.S. Cl. 709/204

(57) ABSTRACT

A plurality of terminal apparatus store segmented content data, which are content data segmented, distributed as a first content file. A plurality of distribution servers store the content data, or segmented content data which are the content data segmented, distributed as a second content file. The terminal acquires a plurality of the first content files from a plurality of other terminal apparatuses via a network. Also, the terminal acquires a first content file which cannot be acquired from the other terminal apparatuses, or a second content file corresponding to the first content file, from the distribution server via the network. A data size of the first content file is smaller than a data size of the second content file.

### CROSS-REFERENCE TO RELATED APPLICATION(S)

This application is based on and claims the benefit of priority from Japanese Patent Application No. 2008-160149 filed on Jun. 19, 2008; the entire contents of which are incorporated herein by reference.

### BACKGROUND

1. Field

The present invention relates to an information distribution system which distributes content such as music data, movie data, and document data to a terminal apparatus, a terminal apparatus, a distribution server and an introduction server in the information distribution system, and a recording medium on which is recorded a program thereof.

2. Description of the Related Art

To date, an information distribution system has been known which constructs an overlay network in which a plurality of terminal apparatus are connected via an information communication line, such as the Internet, and a bi-directional information communication is possible among the terminal apparatus. The information distribution system also virtually constructs an enormous storage configured of a storage group of the plurality of terminal apparatus by causing various content data to be stored in a storage (a storage section) in each terminal apparatus.

In this kind of information distribution system, in order to guarantee that all content data introduced into the system can be distributed, it is necessary that each item of content data is stored in at least one terminal apparatus which is participating in the information distribution system.

However, with this information distribution system, as the virtual storage is configured of a storage group of the plurality of terminal apparatus, as heretofore described, there is a problem in that, when an arbitrary terminal apparatus withdraws from the network of the information distribution system at an arbitrary timing. In the event that there are content data which are stored only in the terminal apparatus which has withdrawn, it becomes impossible to completely guarantee all the content data introduced into the information distribution system.

Therein, an information distribution system has been contrived in which is provided, separately from the distributed storage with the terminal apparatus, a distribution server which stores all the content data introduced into the information distribution system, and can distribute the content data in response to a request from the terminal apparatus.

However, when attempting to enable all the content data introduced into the information distribution system to be distributed by one distribution server, there is a danger that the equipment costs entailed therein will increase significantly.

That is, in order to guarantee a ballooning amount of content data with one server, as well as a high-performance, high-cost server including a large scale storage being needed, a back-up distribution server having the same level of performance as the distribution server is also needed in order to deal with the maintenance of, and an occurrence of a fault in, the server. As a result,a problem occurs in that the equipment costs for constructing the information distribution system increase significantly.

### SUMMARY

In order to solve such a problem, it is conceivable to construct an information distribution system which, rather than causing all the content data to be stored in one distribution server, uses a distributed server system (hereafter called a “distribution pool”) wherein the content data are caused to be stored distributed among a plurality of distribution servers.

By constructing the information distribution system using a distribution pool in this way, even in the event that the content data introduced into the information distribution system increase, it is possible to handle the increase in content data simply by adding a comparatively low-priced server apparatus, meaning that it is possible to prevent a significant increase in the costs incurred for equipment.

It is often the case that it is difficult to secure a large storage capacity in the storage (the storage section) of the terminal apparatus. Therefore, in the information distribution system, it may happen that data which are content data segmented (hereafter taken to be “segmented content data”) are distributed, and caused to be held by the plurality of terminal apparatus, effectively utilizing the storage of each terminal apparatus.

In this case, the terminal apparatus, when playing the content data, acquires a plurality of items of segmented content data, generated by the content data to be played being segmented, from the plurality of terminal apparatus, but in the event that the data size of the segmented content data at this time is small, there is an advantage in that it is possible to carry out a checking for alteration in a short time in the terminal apparatus which acquires the segmented content data.

In this way, in the terminal apparatus configuring the information distribution system, by making the data size of the segmented content data small, as well as effectively utilizing the storage of each terminal apparatus, it is possible to reduce the time for checking for alteration of the content data.

However, when making the data size of the segmented content data small, the number of items of content data managed in the distribution server of the heretofore described distributed server system increases. For this reason, there is a problem in that the data management information of the content data held by each distribution server increases. Also, there is a problem in that shared management information, for sharing among the distribution servers file storing information for enabling a transmission and reception of content data among the distribution servers, also increases.

According to an embodiment of the present invention, there is provided an information distribution system, including a plurality of terminal apparatus which store segmented content data, wherein content data are segmented, distributed as a first content file, and a plurality of distribution servers which store the content data, or segmented content data wherein the content data are segmented, distributed as a second content file. The terminal apparatus includes a first acquisition section which acquires a plurality of the first content files from a plurality of other terminal apparatuses via a network, a second acquisition section which acquires a first content file which cannot be acquired from the other terminal apparatuses, or a second content file corresponding to the first content file, from the distribution server via the network. The terminal apparatus further includes a playing section which plays the content data based on the content file acquired by the first acquisition section or the second acquisition section.

A data size of the first content file held by the terminal apparatus is smaller than a data size of the second content file held by the distribution server.

### BRIEF DESCRIPTION OF THE DRAWINGS

FIG. 1 is a diagram showing one example of a connection pattern of each terminal apparatus, each distribution server, and an introduction server in an information distribution system according to one embodiment of the invention;

FIG. 2 is one example of a routing table;

FIG. 3 is a diagram showing how a content file is introduced from the introduction server 10;

FIG. 4 is a diagram showing how a content holder registration message is forwarded by a DHT routing;

FIG. 5 is one example of an index table;

FIG. 6 is a diagram showing one example of how a content holder is searched for by a DHT routing;

FIG. 7 is a diagram showing how the terminal apparatus acquires a content file from the distribution server of a distribution pool 9b;

FIG. 8 is a diagram for illustrating a first content file and second content file introduced from the introduction server;

FIG. 9A is an illustration of a method of determining the distribution server which is to store a new content file;

FIG. 9B is an illustration of the method of determining the distribution server which is to store a new content file;

FIG. 10 is a diagram showing one example of an outline configuration of the terminal apparatus 1;

FIG. 11 is a main process flowchart of the terminal apparatus 1;

FIG. 12 is a flowchart of a timer monitoring process in the terminal apparatus 1;

FIG. 13 is a flowchart of a playing process in the terminal apparatus 1;

FIG. 14 is a flowchart of a message reception process in the terminal apparatus 1;

FIG. 15 is a flowchart of a file reception process in the terminal apparatus 1;

FIG. 16 is a diagram showing one example of an outline configuration of the distribution server 2 in the information distribution system S;

FIG. 17 is a main process flowchart of the distribution server 2;

FIG. 18 is a diagram showing one example of an outline configuration of the introduction server 10 in the information distribution system S;

FIG. 19 is a main process flowchart of the introduction server 10;

FIG. 20 is a flowchart of a segmenting process for the distribution pool in the introduction server 10;

FIG. 21 is a flowchart of a segmenting process for a usernet 9a in the introduction server 10;

FIG. 22 is a main process flowchart of the distribution server of the fourth embodiment;

FIG. 23 is a diagram showing how the terminal apparatus acquires a content file from the distribution server of the distribution pool; and

FIG. 24 is a diagram showing how the terminal apparatus acquires a content file from the distribution server of the distribution pool.

### DETAILED DESCRIPTION

Hereafter, a specific description will be given of embodiments of the invention. In the embodiments, a description is given with a P2P type information distribution system using a distributed hash table as an example but, not being limited to this, it is sufficient that it is a P2P type information distribution system.

### 1. First Embodiment

### 1.1. Configuration and the Like of Information Distribution System S

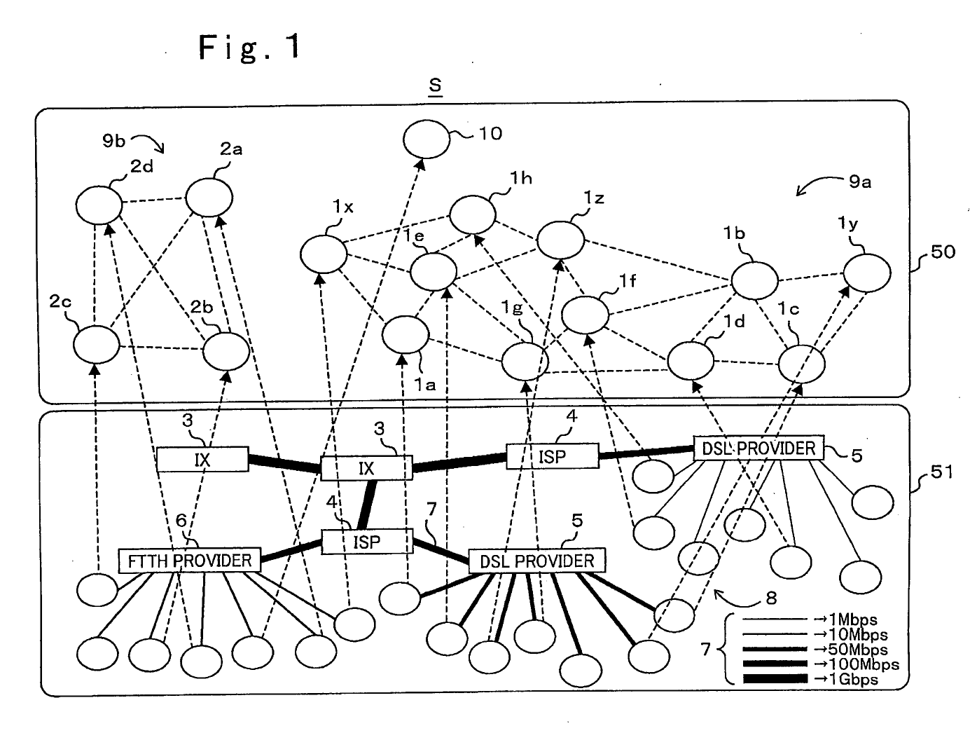

Firstly, referring to FIG. 1, a description will be given of an outline of an information distribution system in a first embodiment of the invention.

As shown inside a lower frame 51 of FIG. 1, a network (a network in the real world) 8, such as the Internet, is configured of an Internet exchange (IX) 3, an Internet Service Provider (ISP) 4, a Digital Subscriber Line (DSL) provider (an apparatus thereof) 5, a Fiber to the Home (FTTH) provider (an apparatus thereof) 6, a communication line (for example, a telephone line or an optical cable) 7, and the like.

An information distribution system S is configured including a plurality of terminal apparatus 1a, 1b, 1c . . . 1x, 1y, 1z . . . , a plurality of distribution servers 2a, 2b, 2c, and 2d, and an introduction server 10, mutually connected via the network 8, as shown inside an upper frame 50 of FIG. 1. A unique manufacturing number (for example, a MAC address), and Internet Protocol (IP) address, are allotted to each terminal apparatus 1a, 1b, 1c . . . 1x, 1y, 1z . . . , and each distribution server 2a, 2b, 2c, and 2d, as information indicating each apparatus. Also, in the following description, when indicating one of the terminal apparatus 1a, 1b, 1c . . . 1x, 1y, 1z . . . , or all of the terminal apparatus, it or they will be called “terminal apparatus 1” for the sake of convenience, and when indicating one of the distribution servers 2a, 2b, 2c, or 2d, or all of the distribution servers, it or they will be called “distribution server 2” for the sake of convenience.

In the information distribution system S of the embodiment, an overlay network configuring a virtual link: formed using the kind of network 8 shown inside the upper frame 50 of FIG. 1 is constructed. The overlay network is configured of a peer-to-peer (P2P) type of network 9a (hereafter called a “usernet 9a”), which is formed from the plurality of terminal apparatus 1a, 1b, 1c . . . 1x, 1y, 1z . . . , and a network 9b (hereafter called a “distribution pool 9b”) which, being formed from the plurality of distribution servers 2a, 2b, 2c, and 2d, distributes content data in response to a request from the terminal apparatus 1. Hereafter, the terminal apparatus 1 disposed in the usernet 9a will be referred to as the terminal apparatus 1 participating in the information distribution system S, and the distribution server 2 disposed in the distribution pool 9b will be referred to as the distribution server 2 participating in the information distribution system S.

Also, the introduction server 10 (one example of a server apparatus), which has a function of introducing a content file into the information distribution system S, a function of generating a list of content files (hereafter taken to be a “content catalog”) which can be acquired in the information distribution system S, and providing it to the terminal apparatus 1 and distribution server 2, and the like, is included in the information distribution system S, as shown in FIG. 1.

1.2. Outline of Usernet 9a

Next, a description will be given, referring to the drawings, of an outline of the usernet 9a.

The usernet 9a being a peer-to-peer (P2P) type of network configured of the plurality of terminal apparatus 1, as heretofore described, in the embodiment, in the same way as in the heretofore described JP-A-2006-197400, it is a P2P type of network using a distributed hash table, and a first content file is transmitted and received among the terminal apparatus 1.

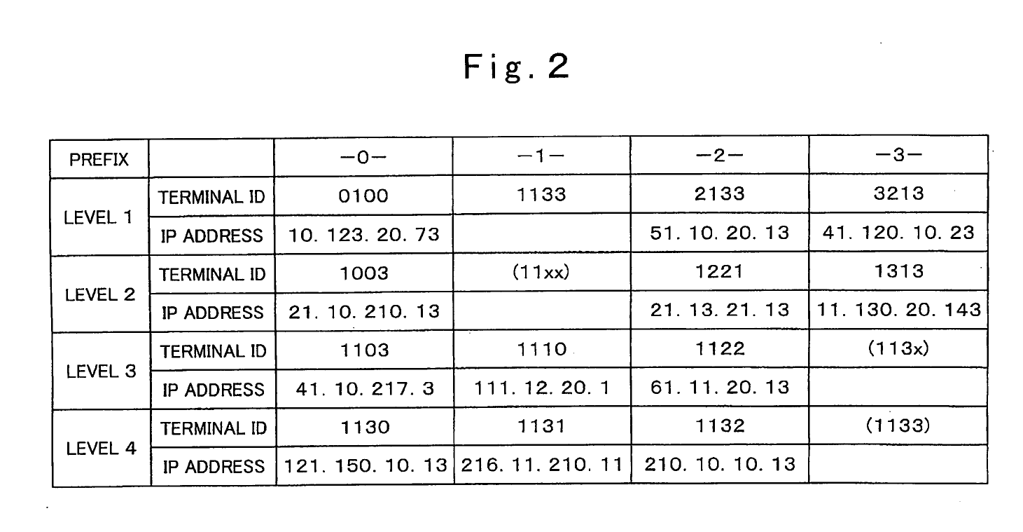

In the usernet 9a, unique identification information (hereafter called “terminal ID”), generated using a hash function, is allotted to each terminal apparatus 1. Then, as shown in FIG. 2, each terminal apparatus 1 stores, in a storage unit, a table (hereafter called a “routing table”) in which is stored location information (herein, the IP addresses) of one portion of the terminal apparatus 1, correlated to the terminal ID thereof (herein, it is taken that the terminal ID are allotted in 8-bit base 4 (“0000” to “3333”)).

Also, the same kind of unique identification information (hereafter called “first file ID”), generated using a hash function, is also allotted to a first content file distributed to and held by the plurality of terminal apparatus 1. Then, a terminal apparatus 1 (hereafter called a “route node”) caused to manage the location information (the IP addresses) of the terminal apparatus (hereafter called a “content holder”) storing the first content file is the terminal apparatus 1 with the terminal ID which has a predetermined relationship with the first file ID of the first content file. For example, it is possible to make the terminal apparatus 1 nearest to the file ID of the first content file the route node which manages the content holder of the first content file. The definition of “nearest terminal apparatus 1” is taken to be the terminal apparatus 1 whose terminal ID is not exceeding the first file ID and the difference between the first file ID and the terminal ID is the smallest.

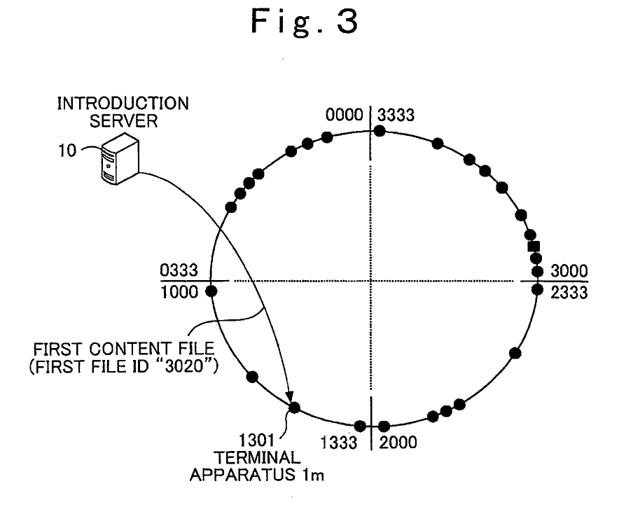

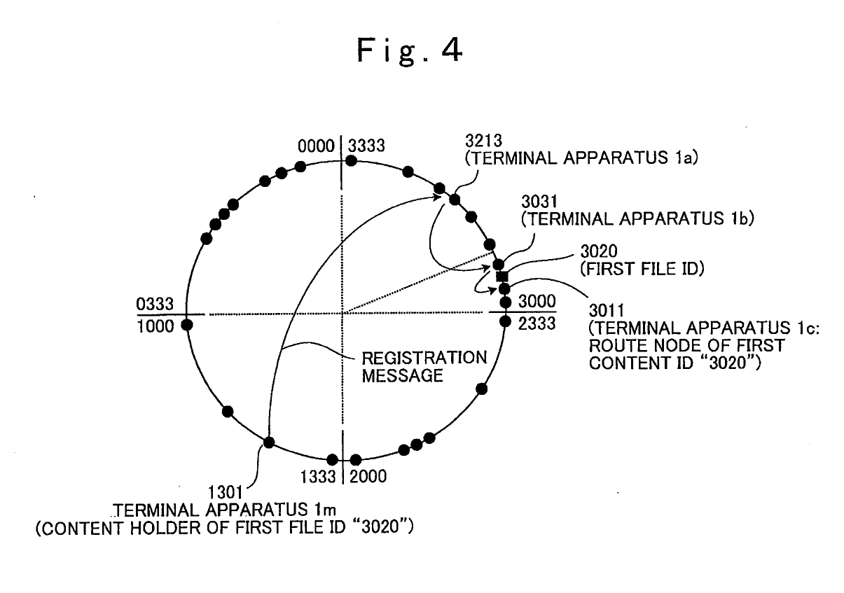

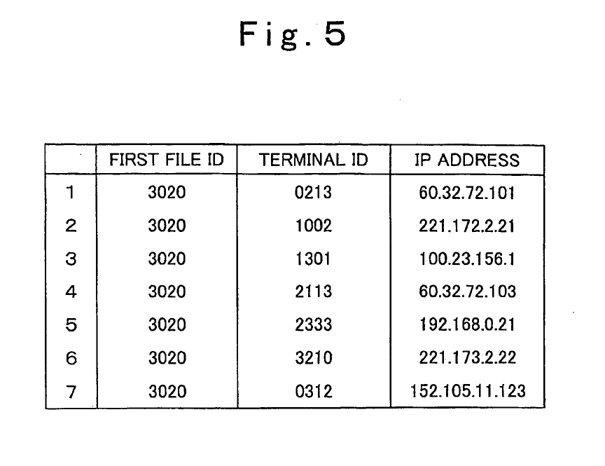

Herein, it is taken that a first content file with first file ID “3020” is newly introduced to a certain terminal apparatus 1m from the introduction server 10, and the terminal apparatus 1m becomes the content holder, as shown in FIG. 3. At this time, as shown in FIG. 4, the terminal apparatus 1m which has become the content holder transmits a registration message, based on the routing table of the apparatus itself, including holder information such as the location information (the IP address) of the apparatus itself, with the first file ID “3020” of the first content file which it is storing as destination identification information. That is, the content holder determines, from the routing table of the apparatus itself, terminal ID near the first file ID which is to be the destination identification information of the registration message, and transmits the registration message to the terminal apparatus 1a, which has the said terminal ID. When the terminal apparatus 1a which receives the registration message determines, based on the index table of the apparatus itself, that the terminal ID nearest to the destination identification information is not that of the apparatus itself, the terminal apparatus 1a determines a terminal ID nearer to the destination identification information, and forwards the registration message to the terminal apparatus 1b, which has the said terminal ID. Then, when the registration message arrives at the terminal apparatus 1c, that is, the route node 1c, which has the terminal ID nearest to the destination identification information, the root node 1c stores the holder information (the location information and the like of the content holder) included in the registration message in the kind of table (hereafter called the “index table”) shown in FIG. 5. The forwarding of a message carried out based on a routing table in the way heretofore described is called a DHT routing.

Subsequently, when a certain terminal apparatus wants to acquire the first content file held by the content holder, a search for and acquisition of the first content file is carried out in the following way. Each terminal apparatus 1, based on the content catalog acquired from the introduction server 10 when joining the information distribution system S, or the like, can search for a desired first content file.

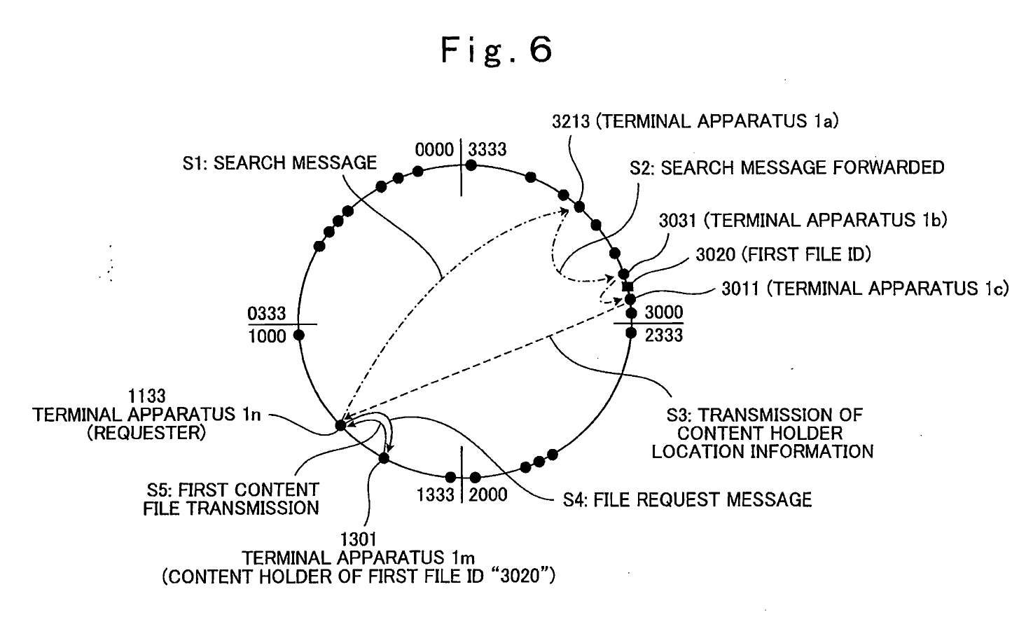

For example, as shown in FIG. 6, the terminal apparatus in (hereafter called the “requester 1n”) which is attempting to acquire a first content file transmits a search message, based on the routing table of the apparatus itself, including the location information of the apparatus itself, with the first file ID of the first content file as destination identification information (refer to S1 shown in FIG. 6). The transmission of the search message being carried out using the same method as for the transmission of the registration message, the message arrives at the route node by means of a DHT routing (refer to S2 shown in FIG. 6). The route node which receives the search message notifies the requester 1n of the location information (the holder information) of the content holder relevant to the request in the index table of the apparatus itself (refer to S3 shown in FIG. 6). Subsequently, the requester makes a request for the first content file by means of a file request message to the content holder with the location information of which it has been notified (refer to S4 shown in FIG. 6), acquires the first content file from the content holder, and plays it (refer to S5 shown in FIG. 6).

Herein, there are times when the content holder has withdrawn from the usernet 9a, and times when the content holder cannot transmit the first content file to the requester due to a reason such as there being an overload.

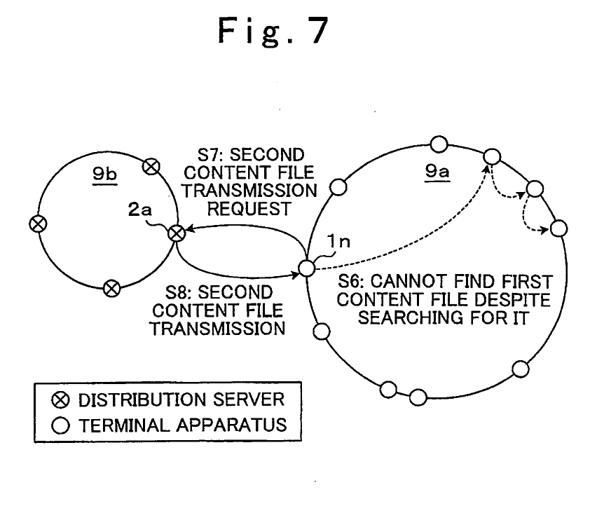

For example, as shown in FIG. 7, when the requester 1n cannot acquire the desired first content file despite searching for it within the usernet 9a (refer to S6 shown in FIG. 7), the requester 1n requests the distribution server 2 of the distribution pool 9b to transmit a second content file corresponding to the first content file the requester 1n wishes to acquire, thereby acquiring it (refer to S7 and S8 shown in FIG. 7). Herein, “a second content file corresponding to the first content file the requester 1n wishes to acquire” means “a second content file” including “the first content file the requester 1n wishes to acquire”. Also, the location information (the IP address) of the distribution server 2 necessary in order to access the distribution server 2 from the requester is specified in advance in a setting file, or the like.

Then, the terminal apparatus 1 which has acquired the second content file acquires information on the first content file it wishes to acquire from the second content file, and plays it.

1.3. Outline of Distribution Pool 9b

The distribution pool 9b being a network using a distributed hash table, in the same way as the usernet 9a, a second content file is transmitted and received among the distribution servers 2.

In the distribution pool 9b, unique identification information (hereafter called “server ID”), generated using a hash function, is allotted to each distribution server 2. Then, each distribution server 2 stores, in a storage unit, the same kind of routing table as the terminal apparatus 1, that is, a routing table in which is stored location information (herein, the IP addresses) of one portion of the distribution servers 2, correlated to the server ID thereof. Also, the same kind of unique identification information (hereafter called “second file ID”), generated using a hash function, is also allotted to a second content file distributed to and held by the plurality of distribution servers 2.

Then, in the same way as the usernet 9a, the distribution server 2 becomes, as the situation demands, the requester, the content holder, or the route node, carries out a process such as holding, searching for, or acquiring a second content file, and carries out a transmission and reception of the second content file. The distribution server 2 acquires the second content file from the introduction server 10, becoming the content holder.

1.4. First Content File and Second Content File

Next, a description will be given, referring to the drawings, of a first content file and second content file.

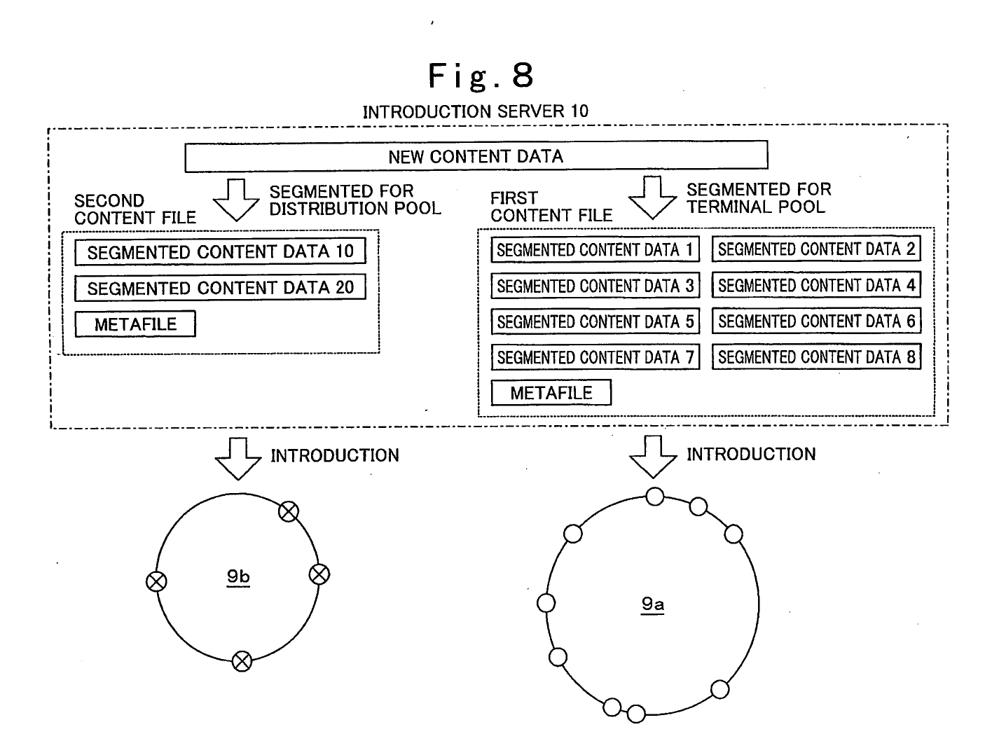

As shown in FIG. 8, the introduction server 10, when introducing new content data (music data, movie data, document data, or the like) into the information distribution system S, generates segmented content data (segmented content data 1 to 7 in the example shown in FIG. 8) wherein the new content data are segmented into first data units, and distributes both the segmented content data, and a metafile to be described hereafter, as a first content file among the plurality of terminal apparatus 1 of the usernet 9a, causing them to store it. Also, the introduction server 10 distributes the new content data as a second content file, or generates segmented content data (segmented content data 10 and 20 in the example shown in FIG. 8) wherein the new content data are segmented into second data units, and distributes the segmented content data, and a metafile to be described hereafter, as a second content file, among the plurality of distribution servers 2 of the distribution pool 9b, causing them to store it.

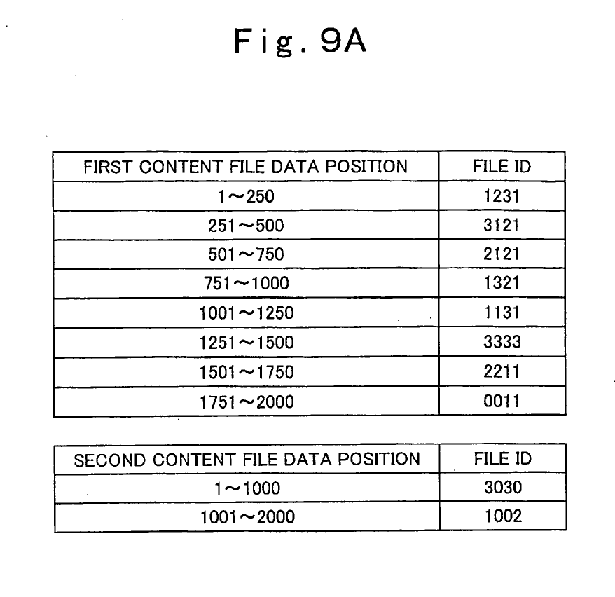

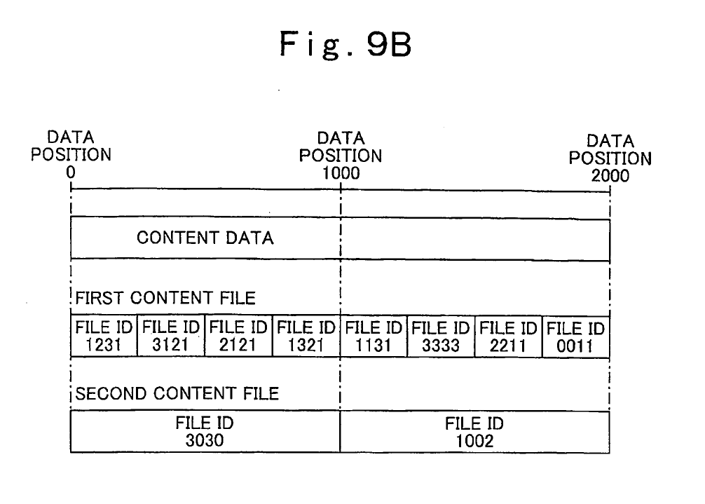

Herein, the metafiles being such as to define a correspondence relationship between a first content file and a second content file, and to stipulates data alignment position of content data in each first content file and each second content file, the information shown in FIG. 9A is stipulated. First file ID and second file ID being given to the metafiles, in the same way as to the first content file and second content file, the metafiles are distributed among and held by the terminal apparatus 1 and distribution servers 2. That is, first file ID is allotted to the metafile to be introduced to the terminal apparatus 1, while second file ID is given to the metafile to be introduced to the distribution servers 2. A value of one portion of the data of the metafile hashed by the heretofore described hash function is given to the metafile as the first file ID in the usernet 9a, and as the second file ID in the distribution pool 9b.

The first file ID and second file ID of the metafiles of each content data name being stipulated in the content catalog, the terminal apparatus 1, when attempting to play content data, firstly acquires the metafile of the content data it is attempting to play, based on the content catalog. The file ID of the segmented content data being stipulated in their playing order in the metafile, as heretofore described, the terminal apparatus 1, while sequentially acquiring the segmented content data 1, the segmented content data 2, and so on, which are the first content files, based on the metafile, via the network 8, sequentially plays the first content files in accordance with their playing order. The metafile being identical for the usernet 9a and the one for the distribution pool 9b, it is possible to use the same ID for the first file ID and the second file ID. By so doing, it no longer being necessary to differentiate between the one for the usernet 9a and the one for the distribution pool 9b when searching for the metafile, it is possible to reduce the processing load in the terminal apparatus 1.

At this time, it is desirable that the data of the first content file are of a small size. This is because, it not being possible to secure a large area as a storage capacity with which to store a content file in the terminal apparatus 1, it is possible to use the disc area effectively when the content file is small, and also because it is possible to reduce the time for carrying out a checking for alteration of a file. However, in the event that the data of the first content file are of too small size, as the cost of managing the file in the terminal apparatus 1 increases and, the amount of holder information stored in the index table increasing, the number of searches increases, it is desirable to set an appropriate data size, taking these points into consideration.

Meanwhile, as it is possible to secure a large area as a storage capacity with which to store a content file in the distribution server 2, even in the event of making the data size of the second content file the same as the data size of the first content file, there is little merit from the point of view of storage capacity. That is, in the event of making the data size of a content file held by the distribution server 2 small despite it being possible to make it large, it is counterproductive in that the cost of managing the file in the distribution server 2 increases and, the amount of holder information stored in the index table increasing, the number of searches increases.

Therein, it is arranged in such a way as to make the data size of the first content file transmitted and received among the terminal apparatus 1 smaller than the data size of the second content file held by the distribution server 2, as shown in FIG. 9B. For this reason, as well as effectively utilizing the storage of each terminal apparatus 1, it is possible to reduce the time for the checking for alteration of a content file, and moreover, it is possible to easily carry out file management in each distribution server 2.

Also, in the embodiment, the segmented content data of each first content file is always included in the second content file. That is, it is arranged in such a way that the segmented content data of one first content file are not divided between two second content files, meaning that, there being no need to search two second content files when searching for one first content file, the process is easier.

However, the terminal apparatus 1, when it cannot acquire the first content file in the usernet 9a, acquires a second content file corresponding to the first content file from the distribution server 2 of the distribution pool 9b, as heretofore described.

At this time, the terminal apparatus 1 generates a search message including the location information of the apparatus itself, with the file ID of the second content file, including the data positions of the first content file it is attempting to acquire, as destination identification information, selects an optional distribution server 2, and transmits the search message. The search message is forwarded by the distribution server 2 of the distribution pool 9b by means of a DHT routing, and arrives at the route node. The route node returns the location information of the content holder storing the second content file which is the subject of the search using the search message to the terminal apparatus 1 which is the request source. The terminal apparatus 1 which receives the reply transmits a file request message including the location information of the apparatus itself, with the file ID of the second content file, including the data positions of the first content file it is attempting to acquire, as destination identification information. The distribution server 2 which is the content holder, which receives the file request message, transmits the second content file requested by the file request message to the terminal apparatus 1 which is the transmission source of the file request message. The terminal apparatus 1, on receiving the second content file from the distribution server 2, extracts the first content file from the second content file, and plays it, based on the data positions stipulated in the metafile.

For example, when the metafile of the content data the terminal apparatus 1 is attempting to play is stipulated as shown in FIG. 9A, and the file ID of the first content file the terminal apparatus 1 is attempting to acquire is “2121”, the terminal apparatus 1 transmits a search message with “3030” as destination identification information to an optional distribution server. On the search message arriving at the route node of the file ID “3030” by means of a DHT routing, the route node transmits the location information of the distribution server 2 which is the content holder of the file ID “3030” to the terminal apparatus 1. The terminal apparatus 1 transmits a file request message to the content holder with the acquired location information, requesting a transmission of the file ID “3030”. The file ID “3030”, and the location information of the terminal apparatus 1, are included in the file request message. The distribution server 2 which is the content holder transmits the second content file with the file ID “3030” to the terminal apparatus 1 which is the transmission source of the file request message. The terminal apparatus 1, on receiving the second content file with the file ID “3030” from the distribution server 2, extracts the first content file with the data positions “501 to 750” from the second content file, and plays it, based on the data positions “501 to 750” stipulated in the metafile.

Hereafter, a description will be given, referring to the drawings, of a specific configuration, and one example of the operation, of the terminal apparatus 1, distribution server 2, and introduction server 10 of the information distribution system S configured in this way.

1.5. Description of Specific Configuration and Operation of Terminal Apparatus 1

Hereafter, a description will be given, referring to the drawings, of a specific configuration, and one example of the operation, of the heretofore described terminal apparatus 1.

Configuration of Terminal Apparatus 1

Firstly, a description will be given of the configuration of the terminal apparatus 1.

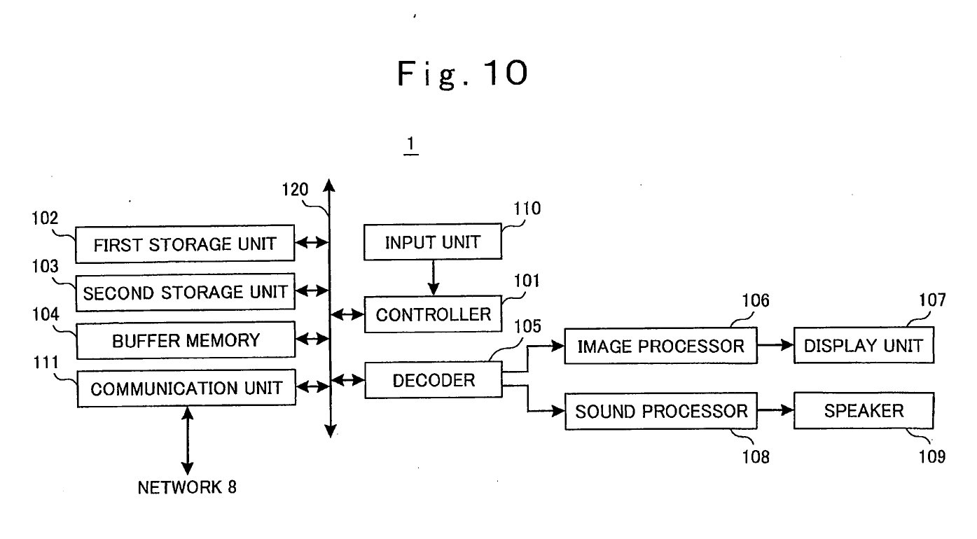

The terminal apparatus 1, a general personal computer being applicable as well as a dedicated computer, includes, as shown in FIG. 10, a controller 101, a rewritable first storage unit 102, which stores a routing table, an index table, and the like, a second storage unit 103 (corresponding to one example of a content storage section and a correspondence information storage section), which is a non-volatile memory storing a content file (including a metafile) acquired from other terminal apparatuses 1, the distribution server 2, or the introduction server 10, a buffer memory 104, which temporarily stores segmented content data which are a content file acquired via the network 8, a decoder 105, which sequentially retrieves and decodes the segmented content data stored in the buffer memory 104, an image processor 106, which processes image information, among the segmented content data decoded by the decoder 105, converting it into information displayable in a display unit 107, to be described hereafter, the display unit 107, such as a liquid crystal display device (LCD), which displays the image of the segmented content data based on an output from the image processor 106, a sound processor 108, which processes sound information, among the segmented content data decoded by the decoder 105, converting it into information transmittable as a sound wave by a speaker 109, to be described hereafter, the speaker 109 which, based on the output from the sound processor 108, transmits the sound of the segmented content data as a sound wave, an input unit 110 configured of a mouse and keyboard, or the like, and a communication unit 111, for communicating with other terminal apparatuses 1, the distribution server 2, and the introduction server 10, via the network 8. The controller 101, first storage unit 102, second storage unit 103, buffer memory 104, decoder 105, and communication unit 111 are mutually connected via a system bus 120. Also, the decoder 105, image processor 106, and sound processor 108 correspond to one example of a playing section.

The controller 101 is configured of a central processing unit (CPU), and an internal memory. An information processing program for participating in the information distribution system S, transmitting and receiving a metafile and segmented content data, which are a content file, and playing the segmented content data being stored in the internal memory, the CPU, by retrieving and executing the information processing program stored in the internal memory, functions as a first acquisition section, a second acquisition section, a third acquisition section, a content transmission section, a playing process section, a storage process section, and the like.

It is acceptable to arrange in such a way that the information processing program is, for example, downloaded from a server (for example, the introduction server 10) connected to the network 8, via the network 8 and communication unit 111, into the internal memory of the controller 101, and it is also acceptable to arrange in such a way that, after being recorded on a recording medium such as a CD-ROM, the program is loaded into the internal memory of the controller 101 via an unshown recording medium drive.

Operation of Terminal Apparatus 1

A specific description will be given, referring to the drawings, of an operation of the terminal apparatus 1 configured in the way heretofore described. Each of the following processes is executed by the controller 101 of the terminal apparatus 1 functioning as each of the heretofore described sections, and the like.

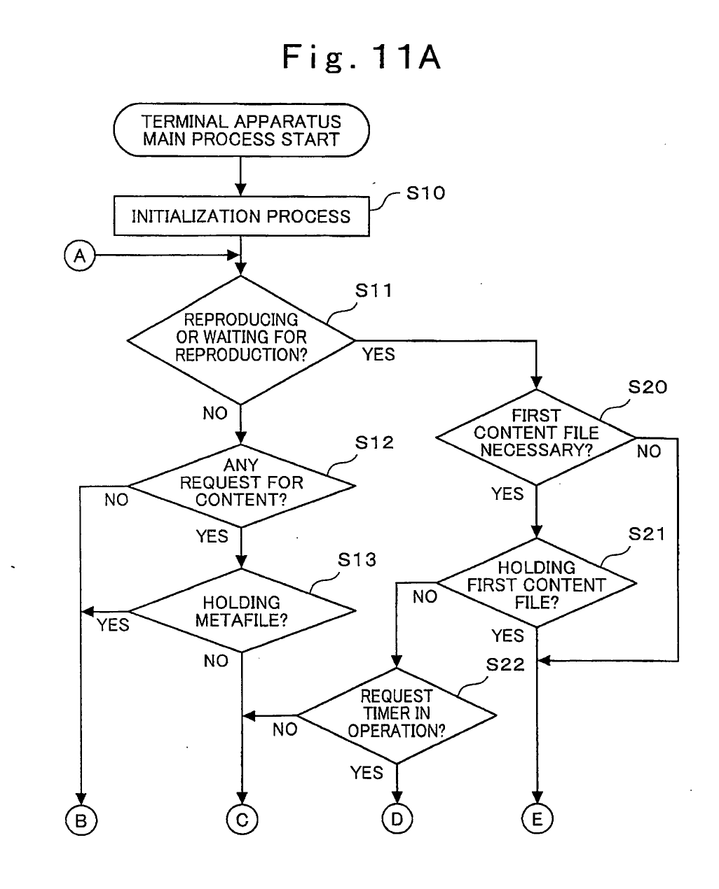

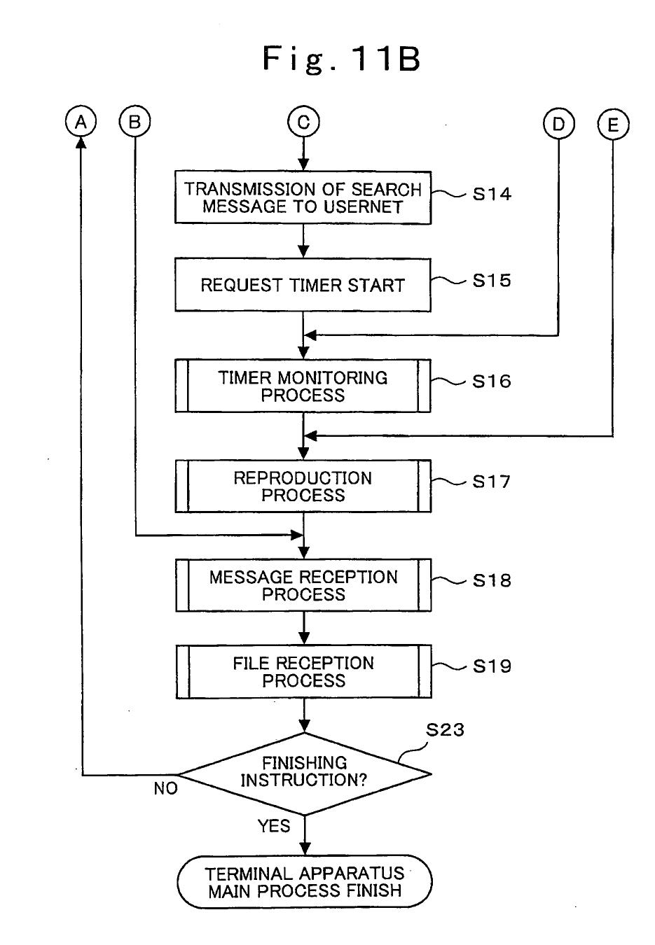

As shown in FIG. 11, when a main power switch (not shown) is activated, or when a reset switch (not shown) is operated, in the terminal apparatus 1, the CPU of the controller 101, executes an initial setting operation, such as a securing of a work area in the internal memory, puts the information processing program stored in the internal memory into an execution state, and puts the function as the controller 101 into an operational state (step S10). The CPU of the controller 101 joins the information distribution system S, and shifts the process to step S11.

In the process of step S11, the controller 101 determines whether or not it is currently playing content, or waiting for a content playing. The controller 101 determines that it is playing content when the first content file of the content data of certain content information is being played or has been played, but the playing of the last content file is not finished, and determines that it is waiting for a content playing when the first content file of the content data of certain content information has not yet been played.

If the controller 101 determines, in this process, that it is not currently playing content, or waiting for a content playing (step S11: No), it determines whether or not there is a request for content (step S12). For example, the controller 101 determines that there is a request for content when there has been a content playing instruction by means of an input into the input unit 110, in a condition in which the information of the content catalog is displayed in the display unit 107.

If the controller 101 determines, in this process, that there is a request for content (step S12: Yes), it determines whether or not it is holding the metafile of the content relating to the request (step S13). The metafile, its first file ID being stipulated in the content catalog, is acquired from other terminal apparatuses 1, or the like, as a first content file using a search message and a file request message.

If the controller 101 determines, in the process of step S13, that it is not storing the metafile (step S13: No), it transmits a search message to the usernet 9a (step S14). That is, the controller 101 retrieves the first file ID of the content relating to the request from the content catalog, and transmits a search message to another terminal apparatus 1 of the usernet 9a, with the first file ID as destination identification information. Subsequently, the controller 101 starts a count with a request timer (step S15). The metafile for the usernet 9a and the one for the distribution pool 9b being identical, as heretofore described, it is possible to use the same ID for the first file ID and the second file ID. By so doing, it is no longer necessary to differentiate between the one for the usernet 9a and the one for the distribution pool 9b when searching for the metafile.

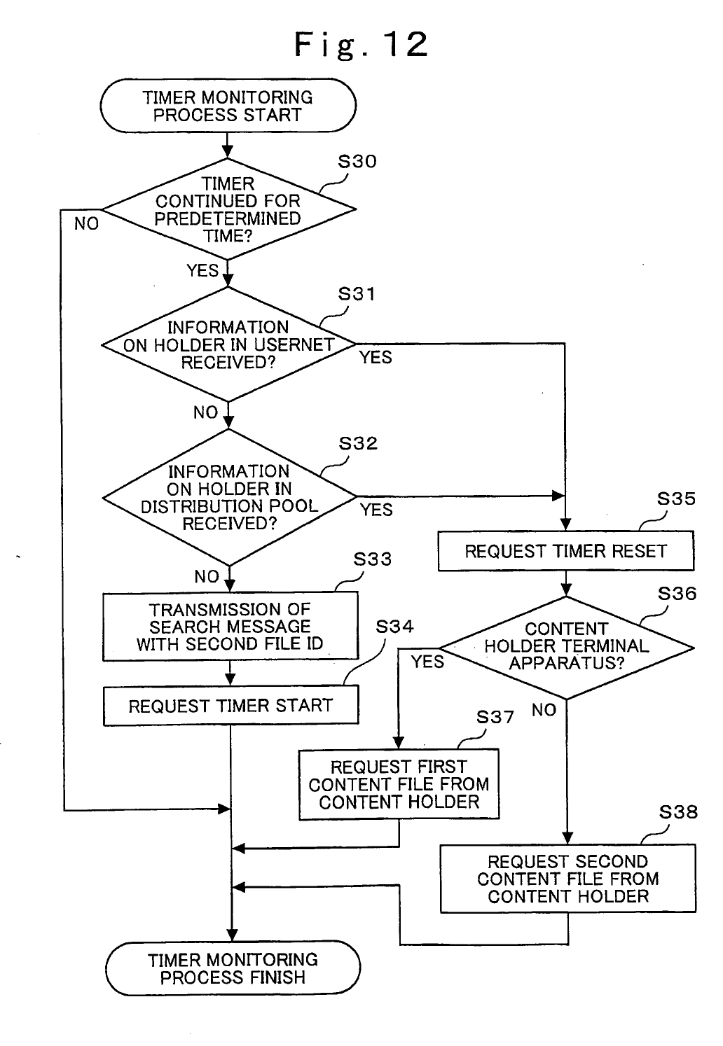

Next, the controller 101 carries out a timer monitoring process in order to acquire a content file (step S16). The timer monitoring process being the process of steps S30 to S38 shown in FIG. 12, it will be described in detail hereafter.

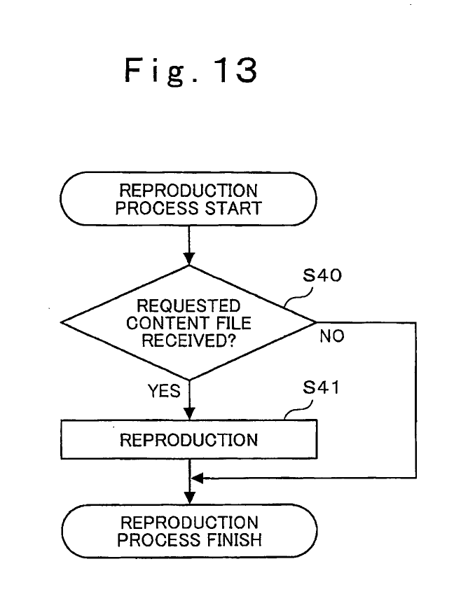

The controller 101 carries out a playing process for playing the content data requested in step S12 (step S17). The playing process being the process of steps S40 and S41 shown in FIG. 13, it will be described in detail hereafter.

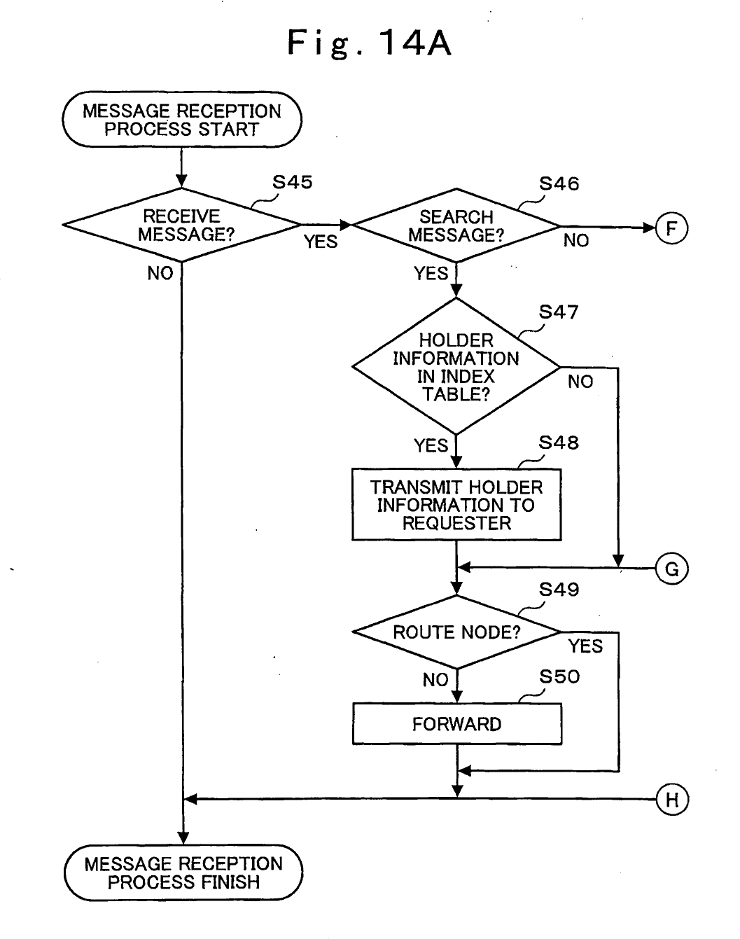

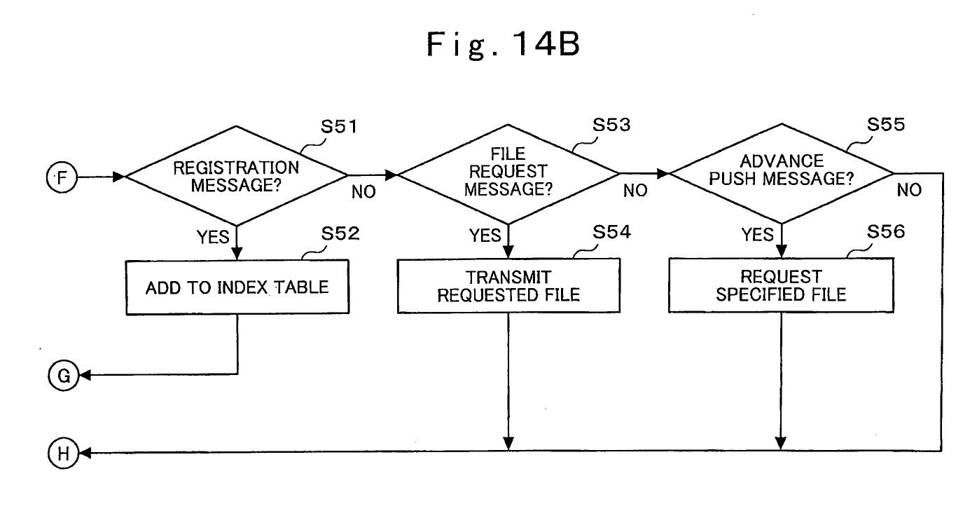

When the process of step S17 is finished, when the controller 101 determines in step S12 that there is no request for content (step S12: No), or when it determines in step S13 that it is storing the metafile (step S13: Yes), the controller 101 carries out a message reception process, receiving and processing various kinds of message transmitted from other terminal apparatuses 1, or the like (step S18). The message reception process being the process of steps S45 to S56 shown in FIG. 14, it will be described in detail hereafter.

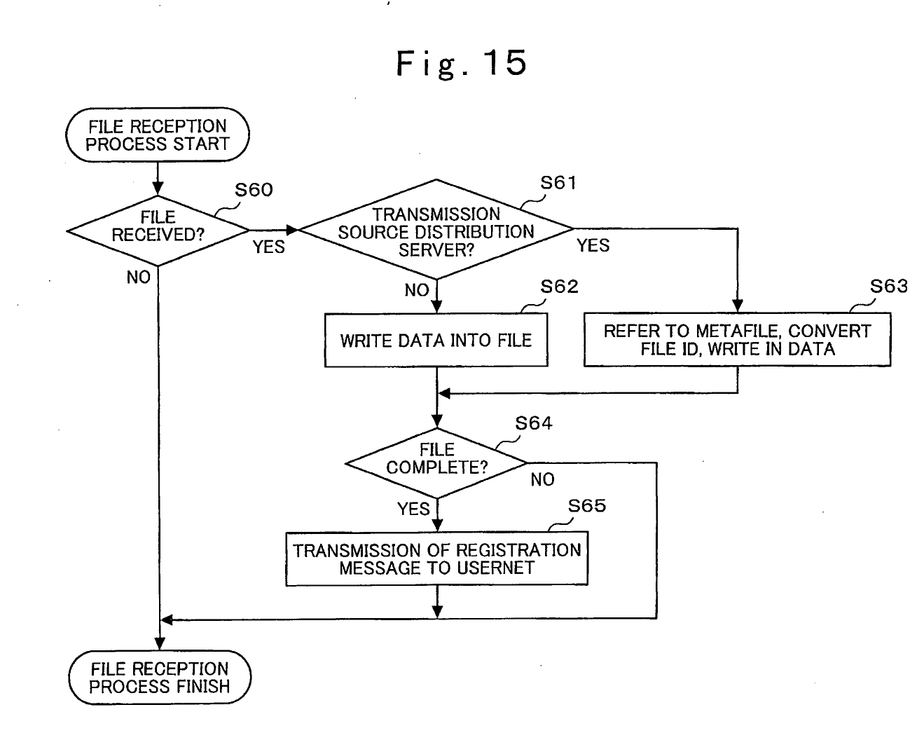

Subsequently, the controller 101 carries out a file reception process, receiving the content file (step S19). The file reception process being the process of steps S60 to S65 shown in FIG. 15, it will be described in detail hereafter.

If the controller 101 determines, in the process of step S11, that it is currently playing content, or waiting for a content playing (step S11: Yes), it determines whether or not a first content file, which is segmented content data, is necessary (step S20). The controller 101 determines, for the content data for which it has determined in the process of step S12 that there has been a request, whether or not there are segmented content data which are to be played.

For example, when the segmented content data of the first content file which have the file ID “3121” are being played when the content data having the metafile shown in FIG. 9A have been requested, the controller 101 determines that there is a first content file which is to be played. Also, when there is a playing waiting condition, in which the segmented content data of the first content file have not yet been played, when the first content data having the metafile shown in FIG. 9A have been requested, the controller 101 determines that there is a first content file which is to be played.

If the controller 101 determines, in the process of step S20, that the first content file is necessary (step S20: Yes), it determines whether or not it is storing the first content file in the second storage unit 103 (step S21). At this time, if the controller 101 determines that it is not storing the first content file (step S21: No), it determines whether or not the count with the request timer is in progress (step S22). Meanwhile, if the controller 101 determines, in the process of step S20, that the first content file is not necessary (step S20: No), or if it determines, in the process of step S21, that it is storing the first content file (step S21: Yes), the controller 101 shifts the process to step S17.

If the controller 101 determines, in the process of step S22, that the request timer is in operation (step S22: Yes), it shifts the process to step S16, while if the controller 101 determines that the count with the request timer is not in progress (step S22: No), it shifts the process to step S14.

When the process of step S19 is finished, the controller 101 determines whether or not it has detected a finishing instruction (step S23). For example, when the power supply of its own apparatus 1 shifts to a deactivated condition, the controller 101 detects the finishing instruction.

If the controller 101 determines, in the process of step S23, that it has detected the finishing instruction (step S23: Yes), it finishes the main process, while if the controller 101 determines that it has not detected the finishing instruction (step S23: No), it repeats the process from step S11.

Next, a specific description will be given, referring to the flowchart of FIG. 12, of the timer monitoring process of step S16. FIG. 12 is a flowchart of the timer monitoring process in the terminal apparatus 1.

As shown in FIG. 12, on starting the timer monitoring process, the controller 101 determines whether or not the count with the request timer has continued for a predetermined time (step S30). If the controller 101 determines, in this process, that the count with the request timer has continued for the predetermined time (step S30: Yes), it determines whether or not it has received information on the holder in the usernet 9a (step S31). That is, the controller 101 determines whether or not it has received the location information of the content holder of the first content file, from the terminal apparatus 1 which is the route node in the usernet 9a, in response to the search message transmitted in step S14.

If the controller 101 determines, in the process of step S31, that it has not received information on the holder in the usernet 9a (step S31: No), it determines whether or not it has received information on the holder in the distribution pool 9b (step S32). That is, the controller 101 determines whether or not it has received the location information (holder information) of the content holder of the second content file, from the distribution server 2 which is the route node in the distribution pool 9b, in response to a search message transmitted in step S33, to be described hereafter. If the controller 101 determines, in this process, that it has not received information on the holder in the distribution pool 9b (step S32: No), it transmits a search message, based on the metafile of the content it is attempting to play, with the second file ID of the second content file corresponding to the first content file as destination identification information (step S33). And the controller starts the count with the request timer from zero (step S34).

In this way, the controller 101 functions as the second acquisition section which, based on the metafile of the content it is attempting to play, requests from the distribution server 2 the second content file corresponding to the first content file which cannot be acquired from other terminal apparatuses 1, thereby acquiring it.

When the controller 101 determines, in the process of step S31, that it has received information on the holder in the usernet 9a (step S31: Yes), or when it determines, in the process of step S32, that it has received information on the holder in the distribution pool 9b (step S32: Yes), the controller 101 resets the count of the request timer, returning it to zero (step S35).

Next, the controller 101 determines whether or not the content holder is the terminal apparatus 1 (step S36). If the controller 101 determines, in this process, that the content holder is the terminal apparatus 1 (step S36: Yes), it requests the first content file from the terminal apparatus 1 which is the content holder, via the communication unit 111 and the network 8 (step S37), and acquires the first content file by means of the file reception process, to be described hereafter. In this way, the controller 101 functions as the first acquisition section, which requests the first content file from the terminal apparatus 1 via the network 8, and acquires the first content file.

Meanwhile, if the controller 101 determines that the content holder is not the terminal apparatus 1 (step S36: No), it requests the second content file from the distribution server 2 which is the content holder, via the communication unit 111 and the network 8 (step S38), and acquires the second content file by means of the file reception process, to be described hereafter. In this way, the controller 101 functions as the second acquisition section, which requests from the distribution server 2, via the network 8, the second content file corresponding to the first content file which cannot be acquired from other terminal apparatuses 1, and acquires the second content file via the network 8.

When the processes of steps S34, S37, and S38 are finished, or if the controller 101 determines, in the process of step S30, that the count with the request timer has not continued for the predetermined time (step S30: No), the controller 101 finishes the timer monitoring process.

Next, a specific description will be given, referring to the flowchart of FIG. 13, of the playing process of step S17.

As shown in FIG. 13, on starting the playing process, the controller 101 determines whether or not it has received the requested content file by means of the file reception process, to be described hereafter (step S40). If the controller 101 determines, in the process, that it has received the requested content file (step S40: Yes), it plays the received content file using the playing section (step S41). That is, the controller 101, while sequentially accumulating the segmented content data of the content file received via the network 8 and the communication unit 111 in the buffer memory 104, retrieves the segmented content data, which are the content file, from the buffer memory. And the controller outputs an image from the display unit 107, or outputs a sound from the speaker 109, in accordance with the segmented content data. In this way, the controller 101 functions as the playing process section which, based on the content file acquired by functioning as the heretofore described first acquisition section or second acquisition section, plays the content data using the playing section.

When the process of step S41 is finished, or when the controller 101 determines, in the process of step S40, that it has not received the requested content file (step S40: No), the controller 101 finishes the playing process.

Next, a specific description will be given, referring to the flowchart of FIG. 14, of the message reception process of step S18.

As shown in FIG. 14, on starting the message reception process, the controller 101 determines whether or not it has received a message from other apparatuses via the network 8 and the communication unit 111 (step S45). If the controller 101 determines, in this process, that it has received a message (step S45: Yes), it determines whether or not the received message is a search message (step S46).

When the controller 101 determines, in the process of step S46, that the received message is a search message (step S46: Yes), it determines whether or not there is holder information in the index table stored in the first storage unit 102 (step S47). That is, the controller 101 determines whether or not it is storing, in the index table stored in the first storage unit 102, the location information of the content holder of the first content file which is the search subject of the received search message. If the controller 101 determines, in this process, that there is holder information (step S47: Yes), it transmits the holder information it is storing, via the communication unit 111 and the network 8, to the terminal apparatus 1 which is the requester which has transmitted the search message (step S48).

When the process of step S48 is finished, or when the controller 101 determines, in the process of step S47, that there is no holder information (step S47: No), the controller 101 determines whether or not its own apparatus is the route node of the first content file which is the search subject of the search message (step S49). If the controller 101 determines that its own apparatus is the route node (step S49: Yes), it finishes the message reception process directly. On the other hand,if the controller 101 determines that its own apparatus is not the route node (step S49: No), it forwards the search message, based on the routing table stored in the first storage unit 102, by means of a DHT routing (step S50), and finishes the message reception process.

If the controller 101 determines, in the process of step S46, that the received message is not a search message (step S46: No), it determines whether or not the received message is a registration message (step S51). If the controller 101 determines, in this process, that the received message is a registration message (step S51: Yes), it adds the index information, such as the location information and terminal ID, of the content holder included in the registration message to the index table stored in the first storage unit 102 (step S52), and shifts the process to step S49.

If the controller 101 determines, in the process of step S51, that the received message is not a registration message (step S51: No), it determines whether or not the received message is a file request message (step S53). If the controller 101 determines, in this process, that the received message is a file request message (step S53: Yes), it retrieves the first content file requested by the file request message from the second storage unit 103, transmits it to the terminal apparatus 1 which is the request source (step S54), and finishes the message reception process. In this way, the controller 101 functions as the content transmission section which, in response to a request from other terminal apparatuses 1, transmits the first content file stored in the second storage unit 103, which is the content storage section.

If the controller 101 determines, in the process of step S53, that the received message is not a file request message (step S53: No), it determines whether or not the received message is an advance PUSH message (step S55). If the controller 101 determines, in this process, that the received message is an advance PUSH message (step S55: Yes), it requests the content file specified by the advance PUSH message from the introduction server 10, via the communication unit 111 and the network 8 (step S56), and finishes the message reception process. Also, when the controller 101 determines, in the process of step S55, that the received message is not an advance PUSH message (step S55: No), it finishes the message reception process.

Herein, information specifying whether the first content file is “to be acquired from the distribution pool 9b”, or “to be acquired from the introduction server 10”, is included in the advance PUSH message received from the introduction server 10, as will be described hereafter. When the information “to be acquired from the distribution pool 9b” is included in the advance PUSH message, the controller 101 of the terminal apparatus 1 requests the specified second content file from the distribution server 2 of the distribution pool 9b, and acquires it by means of the file reception process. Also, when the information “to be acquired from the introduction server 10” is included in the advance PUSH message, the controller 101 requests the specified first content file from the introduction server 10, and acquires it by means of the file reception process, to be described hereafter. In this way, the controller 101 functions as the third acquisition section which, when receiving an advance PUSH message, which is a request from the introduction server 10 to store a content file, acquires the first content file or second content file relating to the storing request in the advance PUSH message from the introduction server 10 or distribution server 2 respectively.

Next, a specific description will be given, referring to the flowchart of FIG. 15, of the file reception process of step S19.

As shown in FIG. 15, on starting the file reception process, the controller 101 determines whether or not it has received the content file via the network 8 and the communication unit 111 (step S60). If the controller determines, in this process, that it has received the content file (step S60: Yes), it determines whether or not the transmission source apparatus is the distribution server 2 (step S61). When the transmission source apparatus is not the distribution server 2, that is, when the transmission source apparatus is the terminal apparatus 1 or the introduction server 10 (step S61: No), the controller 101 writes the segmented content data of the first content file received in the second storage unit 103 (step S62).

Meanwhile, when the transmission source apparatus is the distribution server 2 (step. S61: Yes), the controller 101, referring to the metafile, extracts the first content file from the second content file received, converts the file ID, and writes it into the second storage unit 103 (step S63). That is, the controller 101, based on the metafile, extracts the first content file it wishes to acquire from the second content file received. Then, with the extracted data as the segmented content data of the first content file, the controller 101 converts the file ID from the first file ID of the second content file to the second file ID of the first content file, and writes it into the second storage unit 103. In this way, the controller 101 functions as the second acquisition section, which extracts a first content file which cannot be acquired from other terminal apparatuses 1 from a second content file, and stores it.

When the processes of steps S62 and S63 are finished, the controller 101 determines whether or not the first content file is complete (step S64). That is, the controller 101 determines that the first content file is complete when a data reception for one content file in the second storage unit 103 is finished. When the controller 101 determines, in this process, that the first content file is complete (step S64: Yes), it generates a registration message relating to the first content file and, based on the routing table of its own apparatus, transmits the registration message to another terminal apparatus 1 in the usernet 9a by means of a DHT routing (step S65).

When the controller 101 determines, in the process of step S60, that it has not received the content file (step S60: No), when it determines, in the process of step S64, that the first content file is not complete (step S64: No), or when the process of step S65 is finished, the controller 101 finishes the file reception process.

Herein, the content file determined to have been received in step S60 being the segmented content data or the metafile, when the second content file received from the distribution server 2 is the metafile, the controller 101, referring to the content catalog, converts the file ID. That is, the controller 101 converts the second file ID of the second content file received to the first file ID of the first content file, and stores the second content file in the second storage unit 103 as the first content file. In this way, the controller 101 functions as the storage process section, which stores the metafile, which is correspondence information defining the correspondence relationship between the first content file and the second content file, in the second storage unit 103, which is the correspondence information storage section.

In the way heretofore described, with the terminal apparatus 1 in the first embodiment, by acquiring a second content file corresponding to a desired first content file, and extracting the first content file from the second content file, the desired first content file is acquired.

1.6. Description of Specific Configuration and Operation of Distribution Server 2

Next, a description will be given of a specific configuration, and one example of an operation, of the distribution server 2.

Configuration of Distribution Server 2

Firstly, a description will be given of a specific configuration of the distribution server 2.

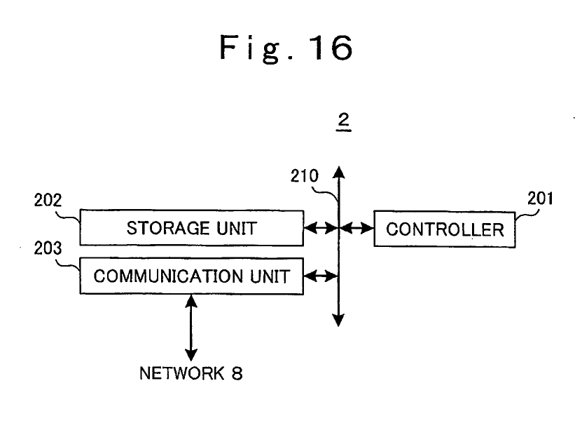

The distribution server 2, a general server computer being applicable, including, as shown in FIG. 16, a controller 201, which controls the whole of the distribution server 2, a rewritable storage unit 202 (corresponding to one example of the content storage section and the correspondence information storage section) having a content storage area in which is stored a second content file (including a metafile), and a communication unit 203, for communicating with the terminal apparatus 1, other distribution servers 2, and the introduction server 10, these are mutually connected via a system bus 210.

The controller 201 is configured of a central processing unit (CPU), an internal memory, and the like. An information processing program for transmitting and receiving a content file, and other messages, to and from the terminal apparatus 1, other distribution servers 2, and the introduction server 10 being stored in the internal memory, the CPU, by retrieving and executing the information processing program stored in the internal memory, functions as a content transmission section, a storage process section, and the like.

It is acceptable to arrange in such a way that the information processing program is, for example, downloaded from another server (for example, the introduction server 10) connected to the network 8, via the communication unit 203, into the internal memory of the controller 201, and it is also acceptable to arrange in such a way that, after being recorded on a recording medium such as a CD-ROM, the program is loaded into the internal memory of the controller 201 via an unshown recording medium drive.

Specific Operation of Distribution Server 2

A specific description will be given, referring to the drawings, of an operation of the distribution server 2 configured in the way heretofore described. Each of the following processes is executed by the controller 201 of the distribution server 2 functioning as each of the heretofore described sections, and the like.

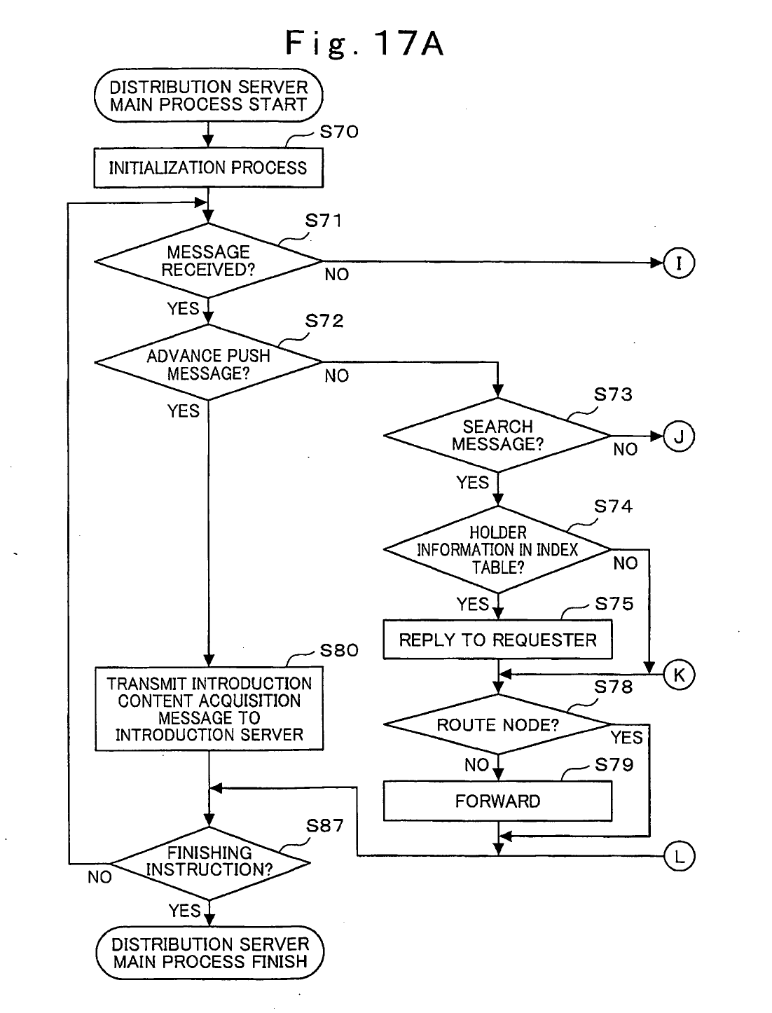

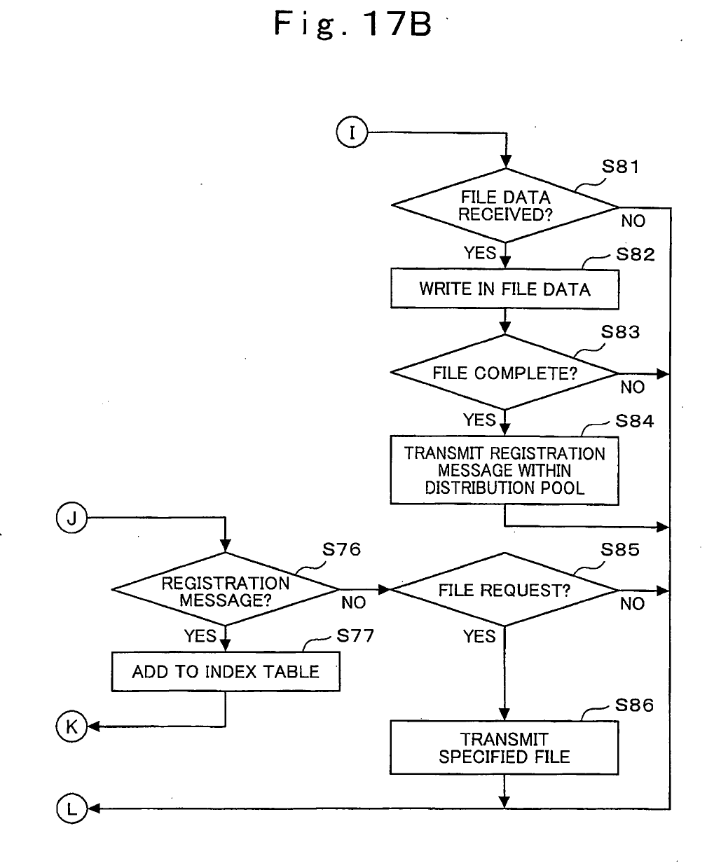

As shown in FIG. 17, when a main power switch (not shown) is activated, or when a reset switch (not shown) is operated, in the distribution server 2, the distribution server 2 carries out an initialization operation (step S70). Specifically, the CPU of the controller 201 executes an initial setting operation, such as a securing of a work area in the internal memory, puts the information processing program stored in the internal memory into an execution state, and puts the function as the controller 201 into an operational state.

Next, the controller 201 determines whether or not it has received a message via the network 8 and the communication unit 203 (step S71). If the controller 201 determines, in this process, that it has received a message (step S71: Yes), it determines whether or not the message is an advance PUSH message (step S72).

If the controller 201 determines, in the process of step S72, that the received message is an advance PUSH message (step S72: Yes), it transmits an introduction content acquisition message to the introduction server 10, via the communication unit 203 and the network 8 (step S80). Meanwhile, if the controller 201 determines that the received message is not an advance PUSH message (step S72: No), it determines whether or not the received message is a search message (step S73). If the controller 201 determines, in this process, that the received message is a search message (step S73: Yes), it determines whether or not holder information is stored in the index table of the storage unit 202 of its own apparatus (step S74). The controller 201, when the location information of the distribution server 2 which is the content holder storing the second content file which is the search subject of the received search message is stored in the index table of the storage unit 202 of its own apparatus, determines that the holder information is stored in the index table.

If the controller 201 determines, in this process, that the holder information is stored in the index table (step S74: Yes), it retrieves the holder information (the location information of the distribution server 2 which is the content holder) from the index table of the storage unit 202, and transmits it to the requester which is the search message transmission source apparatus (step S75).

If the controller 201 determines, in the process of step S73, that the received message is not a search message (step S73: No), it determines whether or not the received message is a registration message (step S76). If the controller 201 determines, at this time, that the received message is a registration message (step S76: Yes), it adds the holder information included in the received registration message to the index table of the storage unit 202 (step S77). Meanwhile, if the controller 201 determines that the received message is not a registration message (step S76: No), it determines whether or not the received message is a file request message (step S85). If the controller 201 determines, at this time, that the received message is a file request message (step S85: Yes), it retrieves the second content file specified by the file request message from the storage unit 202, and transmits the second content file via the communication unit 203 and the network 8 (step S86). In this way, the controller 201 functions as the content transmission section, which transmits a second content file requested by the terminal apparatus 1.

When the processes of steps S75 and S77 are finished, or when the controller 201 determines, in step S74, that the holder information is not in the index table (step S74: No), the controller 201 determines whether or not its own apparatus is the route node (step S78). The controller 201 determines that its own apparatus is the route node when the destination identification information of the received message is nearest to its server ID.

If the controller 201 determines that its own apparatus is not the route node (step S78: No), it forwards the received message, based on the routing table stored in the storage unit 202 of its own apparatus, to another distribution server 2, via the communication unit 203 and the network 8 (step S79).

If the controller 201, in the process of step S71, that it has not received a message (step S72: No), it determines whether or not it has received the data of the content file (step S81). If the controller 201 determines, in this process, that it has received the data of the content file (step S81: Yes), it writes the received data in the storage unit 202 (step S82). In this way, the controller 201 functions as the storage process section, which causes the storage unit 202, as the content storage section, to store the second content file.

Next, the controller 201 determines whether or not all of the data of the second content file have been stored in the storage unit 202 by writing in the data in the process of step S82, and the second content file is complete in the storage unit 202 (step S83). When the controller 201 determines, at this time, that the second content file is complete (step S83: Yes), it transmits a registration message within the distribution pool 9b (step S84). That is, the controller 201 generates a registration message with the second file ID of the completed second content file as the destination identification information, and the location information and the like of its own apparatus as the holder information, and transmits the registration message, based on the routing table stored in the storage unit 202 of its own apparatus, by means of a DHT routing.

When the processes of steps S79, S80, and S86 are finished, when the controller 201 determines, in the process of step S78, that its own apparatus is the route node (step S78: Yes), when the controller 201 determines, in step S81, that it has not received the content file data (step S81: No), when the controller 201 determines, in the process of step S83, that the content file is not complete (step S83: No), or when the controller 201 determines that the message received in step S85 is not a file request message (step S85: No), the controller 201 determines whether or not it has detected a finishing instruction (step S87). For example, when the power supply of its own apparatus shifts to a deactivated condition, the controller 201 detects a finishing instruction.

If the controller 201 determines, in the process of step S87, that it has detected a finishing instruction (step S87: Yes), it finishes the main process, while if the controller 201 determines that it has not detected a finishing instruction (step S87: No), it repeats the process from step S71.

In the way heretofore described, with the distribution server 2 in the first embodiment, communication with the terminal apparatus 1 and other distribution servers 2 is carried out by a DHT routing, and a second content file requested by the terminal apparatus 1 is transmitted.

1.7. Description of Specific Configuration and Operation of Introduction Server 10

Next, a description will be given of a specific configuration, and one example of an operation, of the introduction server 10.

Configuration of Introduction Server 10

Firstly, a description will be given of a specific configuration of the introduction server 10.

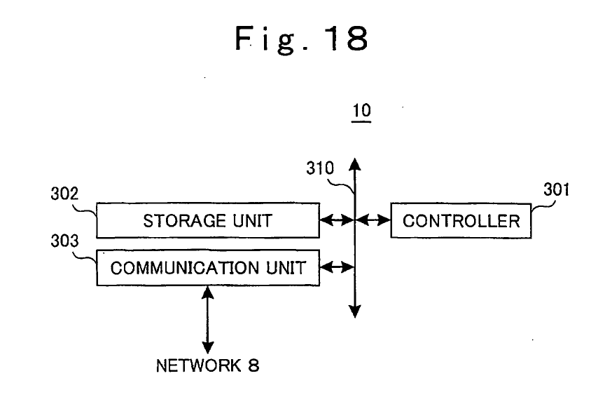

The introduction server 10, a general server computer being applicable, including, as shown in FIG. 18, a controller 301, which controls the whole of the introduction server 10, a rewritable storage unit 302 having a content storage area in which is stored content data, and a communication unit 303 for communicating with the terminal apparatus 1 and distribution server 2, these are mutually connected via a system bus 310.

The controller 301 is configured of a central processing unit (CPU), an internal memory, and the like. An information processing program for transmitting and receiving a content file, and other messages, to and from the terminal apparatus 1 and distribution server 2 being stored in the internal memory, the CPU, by retrieving and executing the information processing program stored in the internal memory, functions as a first introduction section, a second introduction section, and the like.

It is acceptable to arrange in such a way that the information processing program is, for example, downloaded from another server connected to the network 8, via the communication unit 303, into the internal memory of the controller 301, and it is also acceptable to arrange in such a way that, after being recorded on a recording medium such as a CD-ROM, the program is loaded into the internal memory of the controller 301 via an unshown recording medium drive.

Specific Operation of Introduction Server 10

A specific description will be given, referring to the drawings, of an example of an operation of the introduction server 10 configured in the way heretofore described. Each of the following processes is executed by the controller 301 of the introduction server 10 functioning as each of the heretofore described sections, and the like.

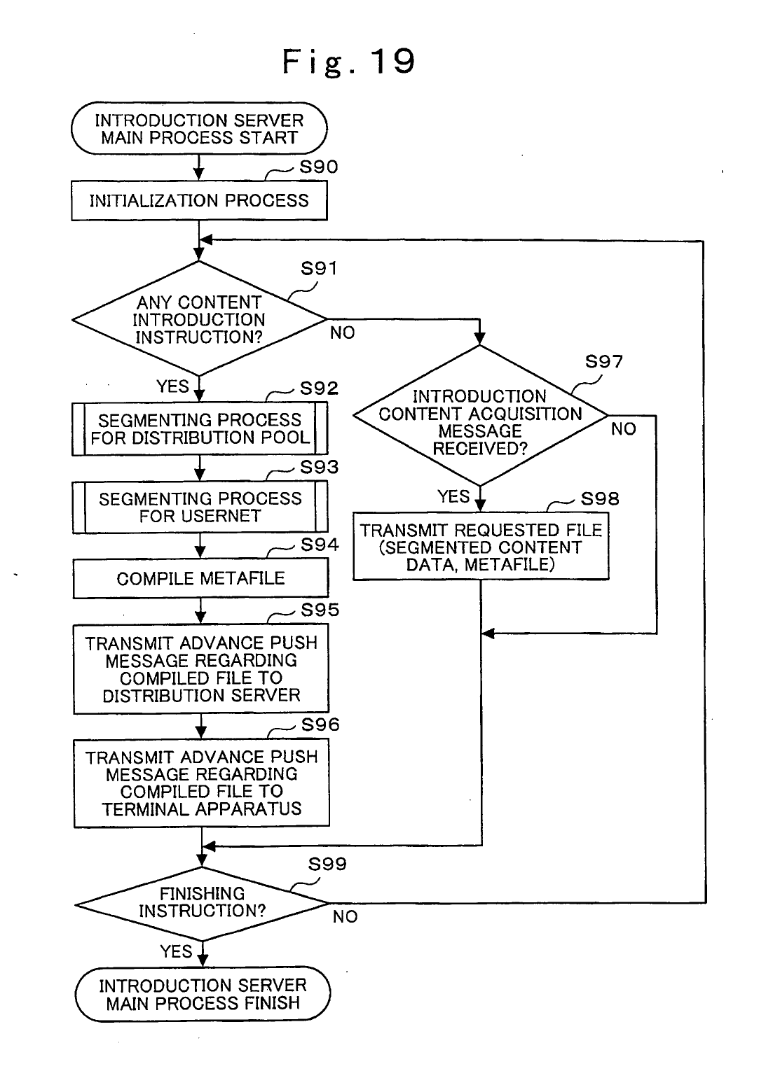

As shown in FIG. 19, when a main power switch (not shown) is activated, or when a reset switch (not shown) is operated, in the introduction server 10, the introduction server 10 carries out an initialization operation (step S90). Specifically, the CPU of the controller 301 executes an initial setting operation, such as a securing of a work area in the internal memory, puts the information processing program stored in the internal memory into an execution state, and puts the function as the controller 301 into an operational state.

Next, the controller 301 determines whether or not there is a content file introduction instruction (step S91). Herein, the controller 301 determines that there is a content file introduction instruction when there has been an instruction for an introduction of new content from a management apparatus (not shown), via the network 8 and the communication unit 303. The content data of the new content are included in the instruction for an introduction of new content.

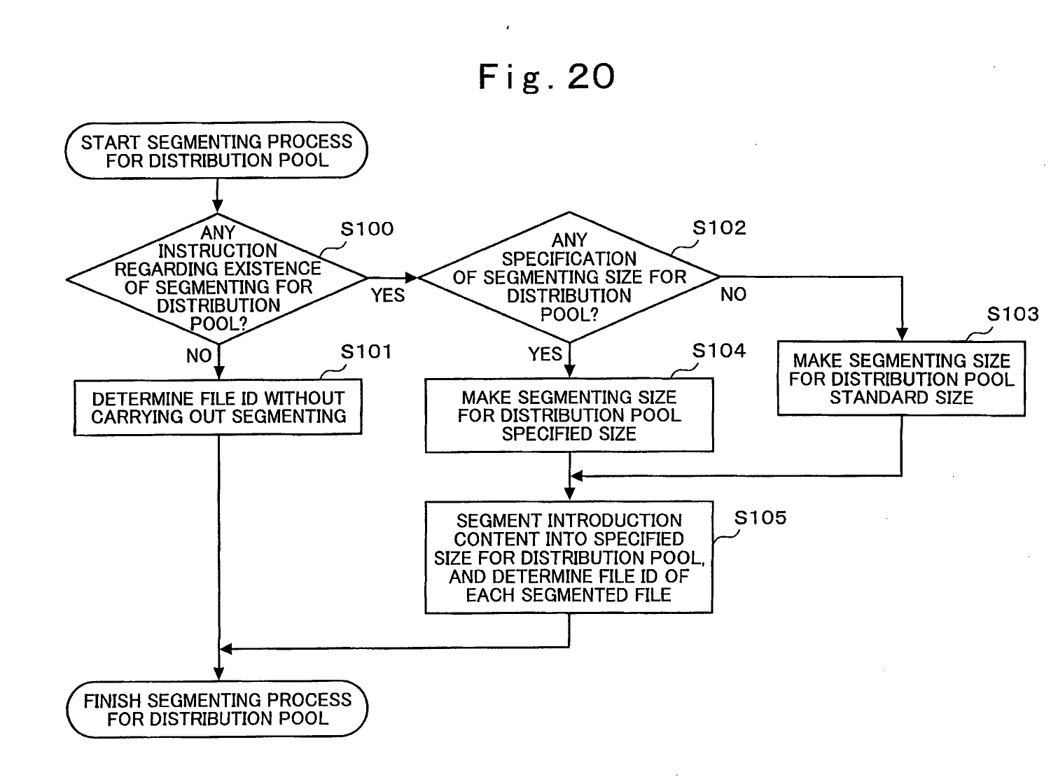

When the controller 301 determines, in the process of step S91, that there is a content file introduction instruction (step S91: Yes), it carries out a segmenting process for the distribution pool 9b (step S92). This process being the process of steps S100 to S105 of FIG. 20, it will be described in detail hereafter.

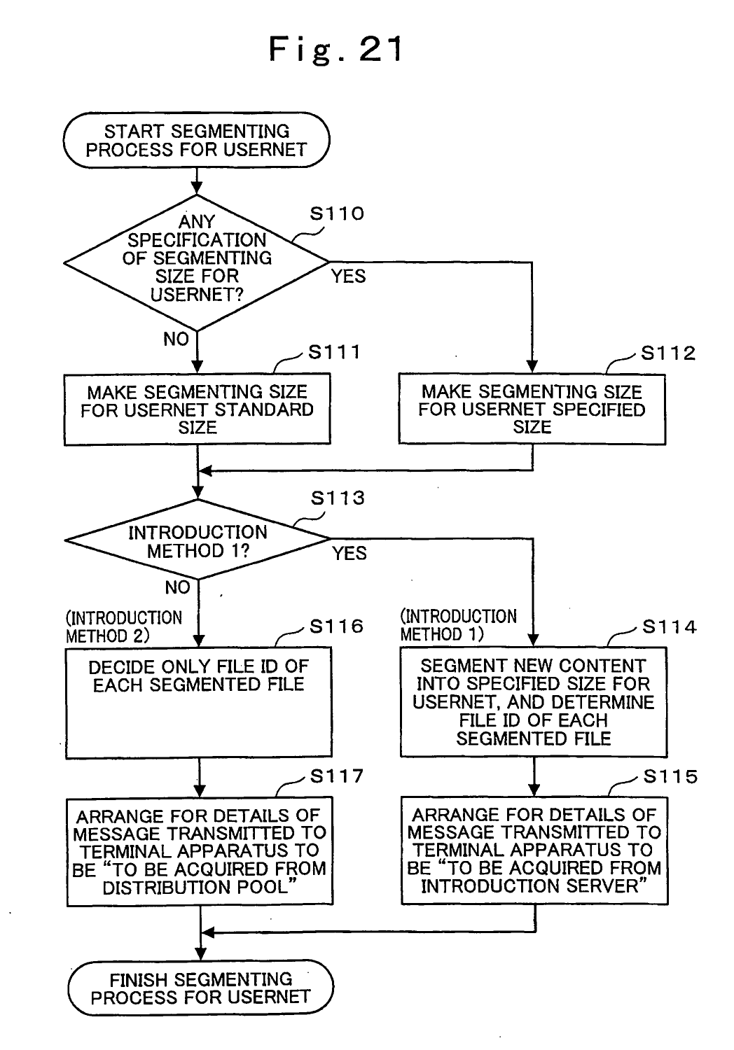

Next, the controller 301 carries out a segmenting process for the usernet 9a (step S93). This process being the process of steps S110 to S117 of FIG. 21, it will be described in detail hereafter.

Next, the controller 301 compiles the metafile of the content for which there has been an introduction instruction (step S94), generates an advance PUSH message for each of the metafile and the second content file newly compiled in the process of step S92, and transmits them, via the communication unit 303 and the network 8, to a plurality of arbitrarily selected distribution servers 2 (step S95). Also, in the same way, the controller 301 generates an advance PUSH message for each of the metafile and the second content file newly compiled in the process of step S93, and transmits them, via the communication unit 303 and the network 8, to a plurality of arbitrarily selected terminal apparatus 1 (step S96).

If the controller 301 determines, in the process of step S91, that there is no content introduction instruction (step S91: No), it determines whether or not it has received an introduction content acquisition message, via the network 8 and the communication section 303, from the terminal apparatus 1 or the distribution server 2 (step S97). If the controller 301 determines, in this process, that it has received an introduction content acquisition message (step S97: Yes), it transmits the segmented content data or metafile, which are the content file requested by the introduction content acquisition message, via the communication section 303 and the network 8 (step S98).

Herein, an introduction content acquisition message from the terminal apparatus 1 is a first content file transmission request, while an introduction content acquisition message from the distribution server 2 is a second content file transmission request. In this way, the controller 301 functions as the first introduction section, which transmits a second content file to the distribution server 2, and the second introduction section, which requests a plurality of terminal apparatus 1 to store a first content file.

When the processes of steps S96 and S98 are finished, or if the controller 301 determines, in the process of step S97, that it has not received an introduction content acquisition message (step S97: No), the controller 301 determines whether or not it has detected a finishing instruction (step S99). For example, when the power supply of its own apparatus shifts to a deactivated condition, the controller 301 detects the finishing instruction.

If the controller 301 determines, in step S99, that it has detected a finishing instruction (step S99: Yes), it finishes the main process, while if the controller 301 determines that it has not detected a finishing instruction (step S99: No), it repeats the process from step S91.

Next, a specific description will be given, referring to the flowchart of FIG. 20, of the segmenting process for the distribution pool of step S92.

As shown in FIG. 20, on starting the segmenting process for the distribution pool, the controller 301 determines whether or not there is an instruction regarding the existence of a segmenting for the distribution pool 9b in the content introduction instruction from the management apparatus (step S100). If the controller 301 determines, in this process, that there is no instruction regarding the existence of a segmenting for the distribution pool 9b (step S100: No), it determines the file ID with the new content data themselves as the second content file, without carrying out a segmenting of the new content data for the distribution pool 9b (step S101), and finishes the segmenting process for the distribution pool 9b.

If the controller 301 determines, in the process of step S100, that there is an instruction regarding the existence of a segmenting for the distribution pool 9b (step S100: Yes), it determines whether or not there is a specification of the segmenting size for the distribution pool 9b in the content introduction instruction (step S102). If the controller 301 determines, in this process, that there is no specification of the segmenting size for the distribution pool 9b (step S102: No), it decides that the segmenting size is to be the standard size stored in advance in the storage unit 302 (step S103), while if the controller 301 determines that there is a specification of the segmenting size for the distribution pool 9b (step S102: Yes), it decides that the segmenting size of the new content data is to be the specified segmenting size (step S104). Then, the controller 301 segments the new content data into the specified segmenting size for the distribution pool 9b, generates a plurality of items of segmented content data, determines the file ID with each item of segmented content data as the second content file (step S105), and finishes the segmenting process for the distribution pool 9b.

Next, a specific description will be given, referring to the flowchart of FIG. 21, of the segmenting process for the usernet of step S93.

As shown in FIG. 21, on starting the segmenting process for the usernet 9a, the controller 301 determines whether or not there is a specification of the segmenting size for the usernet 9a in the content introduction instruction from the management apparatus (step S110). If the controller 301 determines, in this process, that there is no specification of the segmenting size for the usernet 9a (step S110: No), it decides that the segmenting size is to be the standard size stored in advance in the storage unit 302 (step S111), while if the controller 301 determines that there is a specification of the segmenting size for the usernet 9a (step S111: Yes), it decides that the segmenting size of the new content data is to be the specified segmenting size (step S112). The segmenting size of the new content data at this time is set to be smaller than the size of the second content file data.

Next, the controller 301 determines whether or not an introduction method 1 is stipulated in the content introduction instruction from the management apparatus (step S113). If the controller 301 determines, in this process, that the introduction method 1 is stipulated (step S113: Yes), it generates segmented content data wherein the new content data to be introduced are segmented into the specified segmenting size for the usernet 9a and, with each item of segmented content data as the second content file, determines the file ID allotted to each item (step S114). And then, the controller 301 arranges for the details of a message to be transmitted to the terminal apparatus 1 to be “to be acquired from the introduction server” (step S115), and finishes the segmenting process for the usernet 9a.

Meanwhile, if the controller 301 determines that the introduction method 1 is not stipulated in the content introduction instruction from the management apparatus (step S113: No), it determines the file ID allotted to each item of segmented content data which are the second content file in the case of segmenting the new content data to be introduced into the specified segmenting size for the usernet 9a and generating segmented content data (step S116). And then,the controller 301 arranges for the details of a message to be transmitted to the terminal apparatus 1 to be “to be acquired from the distribution pool” (step S117), and finishes the segmenting process for the usernet 9a.

In the way heretofore described, with the introduction server 10 in the first embodiment, when introducing new content data into the information distribution system S, the new content data are introduced to the terminal apparatus 1 of the usernet 9a as a first content file for the usernet 9a, and the new content data are introduced to the distribution servers 2 within the distribution pool 9b as a second content file for the distribution pool 9b. At this time, it being arranged in such a way that the size of the first content file data is smaller than the size of the second content file data, as well as effectively utilizing the storage of each terminal apparatus 1, it is possible to reduce the time for carrying out a checking for alteration of a content file, and moreover, it is possible to easily carry out file management in each distribution server 2.

Also, as a method of introducing new content data to the terminal apparatus 1 of the information distribution system S, it is possible to choose between the introduction method 1, wherein a first content file is prepared by segmenting the new content data in the introduction server 10, and the first content file is transmitted in response to a request from the terminal apparatus 1, and the introduction method 2, wherein the terminal apparatus 1 is caused to acquire a second content file from the distribution pool 9b, and to extract the first content file from the second content file. By employing the introduction method 1, it is possible to reduce the load on the distribution pool 9b, while by employing the introduction method 2, it is possible to reduce the load on the introduction server 10.

### 2. Second Embodiment

In the heretofore described first embodiment, as a method of the terminal apparatus 1 acquiring a desired first content file from the distribution pool 9b, the terminal apparatus 1 acquires the desired first content file by acquiring a second content file corresponding to the desired first content file, and extracting the first content file from the second content file.

In a second embodiment, as a method of the terminal apparatus 1 acquiring a desired first content file from the distribution pool 9b, the terminal apparatus 1 specifies the data position of the desired first content file, and causes the distribution server 2 storing the second content file corresponding to the first content file to extract the first content file, and transmit it to the terminal apparatus 1.

That is, the controller 101 of the terminal apparatus 1 which acquires the holder information from the distribution pool 9b by means of a search message, rather than requesting, in the process of step S38 shown in FIG. 12, the actual second content file including the data positions of the first content file it is attempting to acquire, transmits a file request message including the file ID of the second content file which includes the data position of the first content file, the data position of the first content file, and the location information of its own apparatus, in order to request a transmission of the first content file it is attempting to acquire. The controller 201 of the distribution server 2 which is the content holder which receives the file request message extracts the first content file from the second content file, based on information on the data position stipulated in the file request message, and transmits it to the terminal apparatus 1. The controller 101 of the terminal apparatus 1, without carrying out the kind of process shown in steps S61 to S63 of FIG. 15, that is, without distinguishing whether the transmission source of the received content file is the terminal apparatus 1 or the distribution server 2, receives the first content file data from the distribution server 2, writes them into the second storage unit 103, and plays the segmented content data which are the first content file.

For example, when the metafile of the content data the controller 101 of the terminal apparatus 1 is attempting to play is stipulated as shown in FIG. 9, and the first file ID of the first content file the controller 101 is attempting to acquire is “2121”, the controller 101 of the terminal apparatus 1 extracts the second file ID “3030” of the second content file including the first content file data with the first file ID “2121” from the metafile stored in the second storage section 103. Then, the controller 101 of the terminal apparatus 1 transmits a search message, with the extracted second file ID “3030” as destination identification information, to an optional distribution server 2 within the distribution pool 9b, via the communication unit 203 and the network 8. On the search message arriving, by means of a DHT routing, at the distribution server 2 which is the route node of the second file ID “3030” in the distribution pool 9b, the route node transmits the location information (the holder information) of the distribution server 2 which is the content holder of the second file ID “3030” to the terminal apparatus 1 which is the transmission source of the search message. The controller 101 of the terminal apparatus 1 transmits a file request message to the content holder with the acquired location information, via the communication unit 203 and the network 8, requesting a transmission of the first content file. The second file ID “3030”, the data positions “501 to 750” of the first content file with the first file ID “2121”, and the location information of the terminal apparatus 1, are included in the file request message. The controller 201 of the distribution server 2 which is the content holder, on receiving the file request message, retrieves the data of the data positions “501 to 750” from the second content file with the second file ID “3030”, and transmits them to the terminal apparatus 1 as the first content file with the first file ID “2121”.

In this way, the controller 101 of the terminal apparatus 1 functions as the second acquisition section, which specifies a data area of a second content file corresponding to a first content file which cannot be acquired from other terminal apparatuses 1 and, via the communication unit 203 and the network 8, requests a transmission of the first content file from the distribution server 2. Also, the distribution server 2 functions as the content transmission section, which extracts the first content file from the second content file data requested by the terminal apparatus 1, and transmits the first content file.

In this way, with the information distribution system S of the second embodiment, as the terminal apparatus 1 takes a content file acquired from the distribution server 2 of the distribution pool 9b to be a first content file, it is possible to reduce the amount of data transmitted and received between the terminal apparatus 1 and distribution server 2, and thus possible to reduce the load on the network 8. Also, as it is possible for the terminal apparatus 1 to store the content file acquired from the distribution server 2 as it is, it is also possible to achieve a reduction in the processing load of the terminal apparatus 1.

### 3. Third Embodiment

With the terminal apparatus of the heretofore described second embodiment, a message including the second file ID, the data positions “501 to 750” of the first content file with the first file ID “2121”, and the location information of the terminal apparatus 1, is generated as a file request message to be transmitted to the content holder in the distribution pool 9b, and transmitted to the content holder in the distribution pool 9b.

In a third embodiment, a message including the first file ID, and the location information of the terminal apparatus 1, but not including the second file ID, is generated as a file request message to be transmitted to the content holder in the distribution pool 9b, and transmitted to the content holder in the distribution pool 9b.

That is, the controller 101 of the terminal apparatus 1 which acquires the holder information from the distribution pool 9b by means of a search message, in the process of step S38 shown in FIG. 12, transmits a file request message including the first file ID and metafile of the first content file it is attempting to acquire, and the location information of its own apparatus. This is not to request the actual second content file itself including the data positions of the first content file it is attempting to acquire, but to request a transmission of the first content file it is attempting to acquire.

The controller 201 of the distribution server 2 which is the content holder which receives the file request message retrieves the first content file which has the first file ID stipulated in the file request message from the storage unit 202, based on the metafile, and transmits it to the terminal apparatus 1. The controller 101 of the terminal apparatus 1, without carrying out the kind of process shown in steps S61 to S63 of FIG. 15, that is, without distinguishing whether the transmission source of the received content file is the terminal apparatus 1 or the distribution server 2, receives the first content file data from the distribution server 2, writes them into the second storage unit 103, and plays the segmented content data which are the first content file.

For example, when the metafile of the content data the controller 101 of the terminal apparatus 1 is attempting to play is stipulated as shown in FIG. 9, and the first file ID of the first content file the controller 101 is attempting to acquire is “2121”, the controller 101 of the terminal apparatus 1 extracts the second file ID “3030” of the second content file including the first content file data with the first file ID “2121” from the metafile stored in the second storage section 103. Then, the controller 101 of the terminal apparatus 1 transmits a search message, with the extracted second file ID “3030” as destination identification information, to an optional distribution server 2 within the distribution pool 9b, via the communication unit 203 and the network 8. On the search message arriving, by means of a DHT routing, at the distribution server 2 which is the route node of the second file ID “3030” in the distribution pool 9b, the route node transmits the location information (the holder information) of the distribution server 2 which is the content holder of the second file ID “3030” to the terminal apparatus 1 which is the transmission source of the search message. The controller 101 of the terminal apparatus 1 transmits a file request message to the content holder with the acquired location information, via the communication unit 203 and the network 8, requesting a transmission of the first content file with the first file ID “2121”. The first file ID “2121”, the metafile, and the location information of the terminal apparatus 1, are included in the file request message. The controller 201 of the distribution server 2 which is the content holder, on receiving the file request message, determines from the metafile included in the message that the second file ID of the second content file corresponding to the first file ID “2121” is “3030”, and that the data positions are “501 to 750”, retrieves the data of the data positions “501 to 750” from the second content file with the second file ID “3030”, and transmits them to the terminal apparatus 1 as the first content file with the first file ID “2121”.

In this way, the controller 101 of the terminal apparatus 1 functions as the second acquisition section, which requests from the distribution server 2 a first content file which cannot be acquired from other terminal apparatuses 1, and acquires the requested first content file from the distribution server 2. Also, the controller 201 of the distribution server 2 functions as the content transmission section which, based on the metafile which is the correspondence information, extracts the first content file requested by the terminal apparatus 1 from the second content file corresponding to the first content file, and transmits the first content file to the terminal apparatus 1 which is the request source, via the communication unit 203 and the network 8.

In the way heretofore described, with the information distribution system S of the third embodiment, as the terminal apparatus 1 takes a content file acquired from the distribution server 2 of the distribution pool 9b to be a first content file, it is possible to reduce the amount of data transmitted and received between the terminal apparatus 1 and distribution server 2, and thus possible to reduce the load on the network 8. Also, as it is possible for the terminal apparatus 1 to store the content file acquired from the distribution server 2 as it is, it is also possible to achieve a reduction in the processing load of the terminal apparatus 1.

### 4. Fourth Embodiment

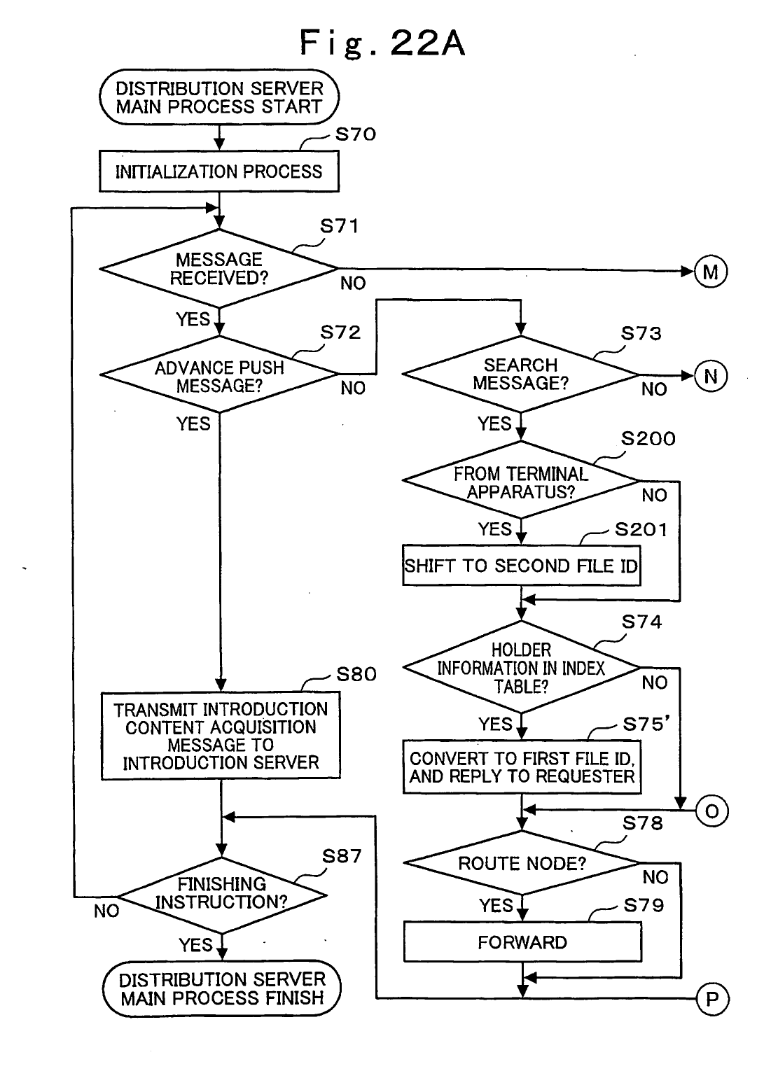

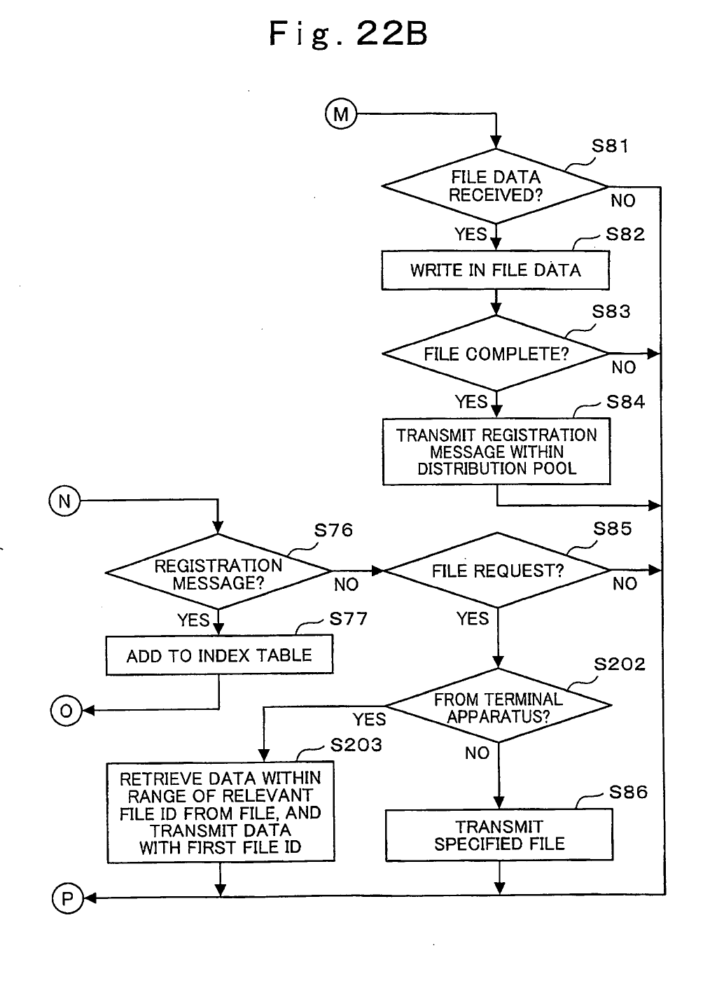

In the heretofore described third embodiment, the second file ID is used as the destination identification information of the search message transmitted to the distribution pool 9b from the terminal apparatus 1, but in the information distribution system S of a fourth embodiment, the first file ID is used. F As the processes of steps S70 to S74, and S81 to S87, in FIG. 22 are the same as the processes described in FIG. 17, a description will be omitted here.

As shown in FIG. 22, if the controller 201 of the distribution server 2 receives a search message (step S73: Yes), it determines whether or not the search message is one transmitted from the terminal apparatus 1 (step S200). If the controller 201 determines, in this process, that the search message is from the terminal apparatus 1 (step S200: Yes), it shifts the destination identification information of the search message to the second file ID (step S201). That is, the controller 201 changes the destination identification information of the search message to the second file ID of the second content file which includes the first content file corresponding to the destination identification information of the search message. Regarding the metafile, which defines the relationship between a first content file and a second content file, the metafiles of all the content in the distribution server 2 are acquired in advance from the introduction server 10. By so doing, it becomes unnecessary to store the metafile, which defines the relationship between a first content file and a second content file, in the terminal apparatus 1 of the usernet 9a (although the metafile which defines the first file ID of the plurality of first content files included in the content is necessary). It is also acceptable that the controller 101 of the terminal apparatus 1 causes the metafile to be included in the search message.

When the controller 201 determines, in the process of step S200, that the search message is not from the terminal apparatus 1 (step S200: No), or when the process of step S201 is finished, the controller 201 of the distribution server 2 determines whether or not there is holder information in the index table (step S74). When there is holder information (step S74: Yes), the controller 201 shifts the process to step S75′. The controller 201, in step S75′, further converts the second file ID converted in the process of step S201 to the first file ID, based on the metafile, and returns the first file ID as the holder information, via the communication unit 203 and the network 8, to the terminal apparatus 1 which has transmitted the search message.

Also, when the controller 201 determines, in the process of step S85, that the received message is a file request message (step S85: Yes), it determines whether or not the file request message is one transmitted from the terminal apparatus 1 (step S202). If the controller 201 determines, in this process, that the file request message is from the terminal apparatus 1 (step S202: Yes), it extracts, from among the second content files stored in the storage unit 202, the second content file having the second file ID corresponding to the first file ID, based on the metafile, and transmits it as the first content file with the first file ID, via the communication unit 203 and the network 8, to the terminal apparatus 1 which has transmitted the file request message (step S203).

In this way, the controller 101 of the terminal apparatus 1 functions as the second acquisition section, which requests from the distribution server 2 a first content file which cannot be acquired from other terminal apparatuses 1, and acquires the requested first content file from the distribution server 2. Also, the controller 201 of the distribution server 2 functions as the content transmission section which, based on the metafile which is the correspondence information, extracts the first content file requested by the terminal apparatus 1 from the second content file corresponding to the first content file, and transmits the first content file to the terminal apparatus 1 which is the request source, via the communication unit 203 and the network 8.

In the way heretofore described, with the information distribution system S of the fourth embodiment, as the terminal apparatus 1 transmits the search message and the file request message to the distribution server 2 of the distribution pool 9b with the first file ID, it is possible to achieve a reduction in storage capacity, because it is unnecessary to store the metafile, which defines the relationship between a first content file and a second content file, in the terminal apparatus 1, and it is possible to achieve a reduction in the processing load, because the process of converting to the second file ID in the terminal apparatus 1 is unnecessary.

### 5. Other Embodiments

In the heretofore described embodiments, the controller 101 of the terminal apparatus 1, when it is not possible to acquire a first content file from other terminal apparatuses 1 in the usernet 9a, acquires the first content file, or a second content file corresponding to the first content file, from the distribution server 2 in the distribution pool 9b, but furthermore, when it is not possible to acquire a first content file from other terminal apparatuses 1 in the usernet 9a, the controller 101 acquires one portion of the first content file by acquiring the one portion of the first content file, or a second content file corresponding to the first content file, from the distribution server 2 in the distribution pool 9b.

For example, the controller 101 of the terminal apparatus 1 transmits a file request message including the second file ID of the second content file which includes the first content file one portion of which it is attempting to acquire, the range of the data positions it is attempting to acquire, and the location information of its own apparatus. The controller 201 of the distribution server 2 which is the content holder which receives the file request message, based on information on the data positions stipulated in the file request message, extracts the data in the range of the stipulated data positions from the second content file, and transmits them to the terminal apparatus 1.

In this way, the controller 101 of the terminal apparatus 1 is caused to function as the second acquisition section which, based on the metafile, specifies a data area of a second content file corresponding to a first content file, one portion of which cannot be obtained from other terminal apparatuses 1, requests a transmission of the data of the one portion of the first content file from the distribution server, and acquires the requested one portion of the first content file from the distribution server 2. Also, the controller 201 of the distribution server 2 is caused to function as the content transmission section, which extracts one portion of the first content file from the data of the second content file requested by the terminal apparatus 1, and transmits the data of the data area specified by the terminal apparatus 1.

Thus, when acquiring a first content file from the content holder in the usernet 9a, the terminal apparatus 1, on determining that it will take time to acquire the first content file due to a problem with the bandwidth, or the like, of the network 8, can acquire one portion of the first content file from the distribution pool 9b, and can carry out the playing of the content file more smoothly.

Also, in the heretofore described embodiments, the correspondence information, which defines the correspondence relationship between a first content file and a second content file, is described as the metafile, but it is also acceptable to arrange in such a way that the correspondence information is included in the content catalog.

Also, in the heretofore described embodiments, the terminal apparatus 1 sends the search message and the file request message, but it is also acceptable to arrange in such a way that the distribution server 2 which receives the file request message transmits the search message within the distribution pool 9b, acquires the content file, and transmits it to the terminal apparatus 1.

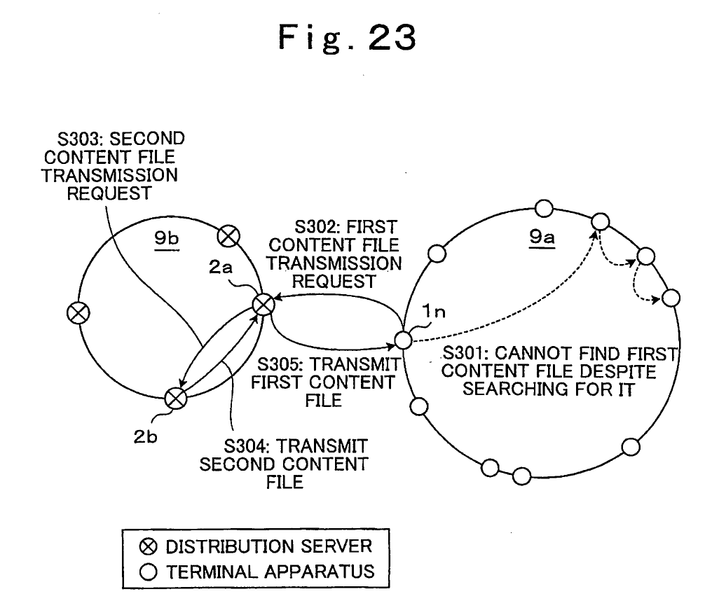

For example, when there is a first content file transmission request from the terminal apparatus 1 (refer to S302 shown in FIG. 23), each distribution server 2, in the event that it determines that it is not storing the second content file corresponding to the first content file, transmits a search message to another distribution server 2. Then, the distribution server 2 acquires the location information of the content holder by means of the search message, makes a second content file transmission request to the content holder (refer to S303 shown in FIG. 23), acquires the second content file relating to the request from the terminal apparatus 1 (refer to S304 shown in FIG. 23), extracts the first content file from the second content file, and transmits it to the terminal apparatus 1 which is the request source (refer to S305 shown in FIG. 23). It is also acceptable to arrange in such a way that the distribution server 2, without extracting the first content file from the second content file, transmits the second content file as it is to the terminal apparatus 1 which is the request source.

In this way, when neither the second content file requested by the terminal apparatus 1, nor the second content file corresponding to the first content file, is in the storage unit 202, which is the content storage section, it is possible to cause the controller 201 of the distribution server 2 to function as the content transmission section, which acquires the second content file from the other distribution servers, and transmits the first content file corresponding to the acquired second content file to the terminal apparatus 1 which is the request source.

Also, in the heretofore described embodiments, the terminal apparatus 1 sends the search message and the file request message, but it is also acceptable to arrange in such a way that the distribution server 2 which receives the file request message requests a transmission of the content file from other distribution servers 2 within the distribution pool 9b, and the distribution server 2 which receives the request transmits the content file to the terminal apparatus 1.

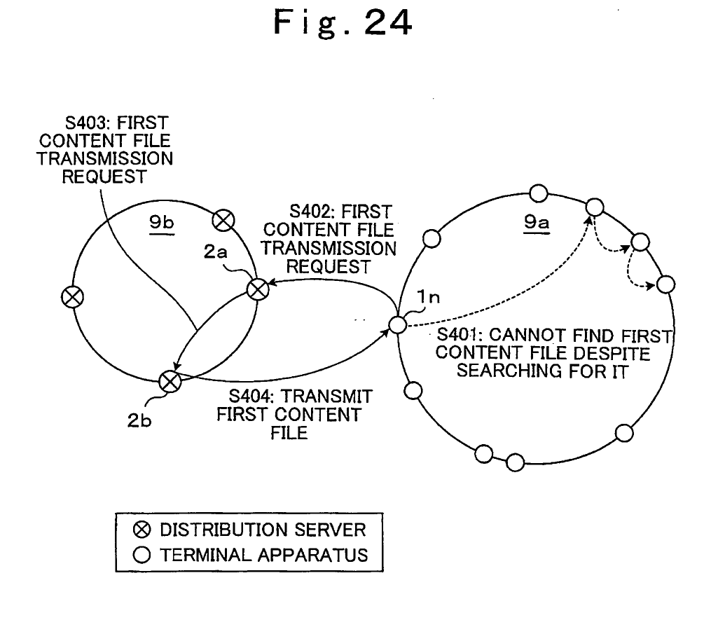

For example, when there is a first content file transmission request from the terminal apparatus 1 (refer to S402 shown in FIG. 24), each distribution server 2, in the event that it determines that it is not storing the second content file corresponding to the first content file, transmits a search message to another distribution server 2. Then, the distribution server 2 acquires the location information of the content holder by means of the search message, makes a first content file transmission request to the content holder (refer to S403 shown in FIG. 24), and the content holder extracts the first content file from the second content file, and transmits it to the terminal apparatus 1 which is the request source (refer to S404 shown in FIG. 24). It is also acceptable to arrange in such a way that the content holder, without extracting the first content file from the second content file, transmits the second content file as it is to the terminal apparatus 1 which is the request source.

In this way, when neither the second content file requested by the terminal apparatus 1, nor the second content file corresponding to the first content file, is in the storage unit 202, which is the content storage section, it is possible to cause the controller 201 of the distribution server 2 to function as a content transmission request section, which requests other distribution servers 2 to carry out a transmission of a second content file with the apparatus itself as the destination, or with the terminal apparatus 1 which has made the request as the destination. And it is also possible to cause the controller 201 of the distribution server 2 to function as the content transmission section which, in response to a request, transmits a first content file or a second content file to other distribution servers 2, with the specified terminal apparatus 1 or the distribution server 2 as the destination.

Although the embodiment and modification of the present invention have been described in detail herein, the scope of the invention is not limited thereto. It will be appreciated by those skilled in the art that various modifications may be made without departing from the scope of the invention. Accordingly, the embodiment and modification disclosed herein are only exemplary. It is to be understood that the scope of the invention is not to be limited thereby, but is to be determined by the claims which follow.

What is claimed is:

1. An information distribution system, comprising:
a plurality of terminal apparatus which store segmented content data, which are content data segmented, distributed as a first content file; and
a plurality of distribution servers which store the content data, or segmented content data which are the content data segmented, distributed as a second content file,
the terminal apparatus including:
a first acquisition section which acquires a plurality of the first content files from a plurality of other terminal apparatuses via a network;
a second acquisition section which acquires a first content file which cannot be acquired from the other terminal apparatuses, or a second content file corresponding to the first content file, from the distribution server via the network; and
a playing section which plays the content data based on the content file acquired by the first acquisition section or the second acquisition section, wherein
a data size of the first content file stored by the terminal apparatus is smaller than a data size of the second content file stored by the distribution server.

2. The information distribution system according to claim 1, wherein
the distribution server includes:
a correspondence information storage section which stores correspondence information defining a correspondence relationship between the first content file and the second content file; and
a content transmission section which, based on the correspondence information stored in the correspondence information storage section, extracts the first content file requested by the terminal apparatus from the second content file corresponding to the first content file, and transmits the first content file, wherein
the second acquisition section of the terminal apparatus requests the first content file which cannot be acquired from the other terminal apparatuses from the distribution server, and acquires the requested first content file from the distribution server.

3. The information distribution system according to claim 1, wherein
the distribution server includes:
a content transmission section which transmits the second content file requested by the terminal apparatus, and
the terminal apparatus includes:
a correspondence information storage section which stores correspondence information defining a correspondence relationship between the first content file and the second content file, wherein
the second acquisition section of the terminal apparatus, based on the correspondence information stored in the correspondence information storage section, acquires the second content file corresponding to the first content file which cannot be acquired from the other terminal apparatuses from the distribution server, extracts the first content file which cannot be acquired from the other terminal apparatuses from the acquired second content file, and stores the first content file.

4. The information distribution system according to claim 1, wherein
the terminal apparatus includes:
a correspondence information storage section which stores correspondence information defining a correspondence relationship between the first content file and the second content file,
the second acquisition section of the terminal apparatus, based on the correspondence information stored in the correspondence information storage section, specifies a data area of the second content file corresponding to the first content file which cannot be acquired from the other terminal apparatuses, and requests a transmission of the first content file from the distribution server, and
the distribution server includes:
a content transmission section which extracts the first content file from the second content file data requested by the terminal apparatus, and transmits the first content file.

5. The information distribution system according to claim 1, wherein
the terminal apparatus includes:
a correspondence information storage section which stores correspondence information defining a correspondence relationship between the first content file and the second content file, wherein,
the second acquisition section of the terminal apparatus, based on the correspondence information stored in the correspondence information storage section, specifies a data area of the second content file corresponding to the first content file one portion of which cannot be acquired from the other terminal apparatus, and requests a transmission of the one portion of the data of the first content file from the distribution server, and
the distribution server includes:
a content transmission section which extracts the one portion of the first content file from the second content file data requested by the terminal apparatus, and transmits the data of the data area specified by the terminal apparatus.

6. The information distribution system according to claim 1, wherein
the distribution server includes:
a content storage section which stores the second content file; and
a content transmission request section which, when neither a second content file requested by the terminal apparatus, nor a second content file corresponding to a first content file, is in the content storage section, requests other distribution servers to carry out a transmission of the second content file, or of the first content file corresponding to the second content file, with the apparatus itself, or the terminal apparatus which has made the request, as a destination.

7. The information distribution system according to claim 1, wherein
the distribution server includes:
a content storage section which stores the second content file; and
a content transmission section which, when neither the second content file requested by the terminal apparatus, nor the second content file corresponding to the first content file, is in the content storage section, acquires the second content file from the other distribution servers, and transmits the acquired second content file to the terminal apparatus which is the request source.

8. The information distribution system according to claim 1, comprising:
an introduction server having a first introduction section which transmits the second content file to the distribution server, and a second introduction section which requests the plurality of terminal apparatus to store the first content file,
the terminal apparatus including:
a third acquisition section which, when there is a first content file storing request from the introduction server, acquires the first content file relating to the storing request from the distribution server;
a content storage section which stores the first content file acquired from the distribution server or the other terminal apparatuses; and
a content transmission section which, in response to a request from the other terminal apparatus, transmits the first content file stored in the content storage section.

9. The information distribution system according to claim 1, comprising:
an introduction server having a first introduction section which transmits the second content file to the distribution server, and a second introduction section which segments the content data or the second content file, generates the first content file, and transmits the first content file to the terminal apparatus,
the terminal apparatus including:
a content storage section which stores the first content file acquired from the introduction server, the distribution server, or the other terminal apparatus; and
a content transmission section which, in response to a request from the other terminal apparatus, transmits the first content file stored in the content storage section.

10. A terminal apparatus in the information distribution system according to claim 1.

11. A distribution server in the information distribution system according to claim 2.

12. A recording medium on which is recorded a program which causes a computer to function as each section of the terminal apparatus in the information distribution system according to claim 1.

13. A recording medium on which is recorded a program which causes a computer to function as each section of the distribution server in the information distribution system according to claim 2.
